(19) United States
(12) Patent Application Publication
(10) Pub. No.: US 2026/0331599 A1
(43) Pub. Date: Oct. 22, 2026

(54) All-Solid-State Lithium-Ion Secondary Battery and Method for Producing Same

(71) Applicant: NATIONAL INSTITUTE FOR MATERIALS SCIENCE, Ibaraki (JP)

(72) Inventors: Narumi OHTA, Tsukuba (JP); Kazunori TAKADA, Tsukuba (JP); Tsuyoshi OHNISHI, Tsukuba (JP); Shoji YAMAGUCHI, Tsukuba (JP)

(73) Assignee: NATIONAL INSTITUTE FOR MATERIALS SCIENCE, Ibaraki (JP)

(21) Appl. No.: 19/114,000

(22) PCT Filed: Sep. 14, 2023
(86) PCT No.: PCT/JP2023/033601

§ 371 Date: Mar. 21, 2025

(30) Foreign Application Priority Data
Sep. 22, 2022 (JP) 2022-150825

(51) Int. Cl. H01M 10/42; H01M 4/587; H01M 10/0525; H01M 10/0562; H01M 10/058; H01M 50/434

(52) U.S. Cl. CPC H01M 10/4235; H01M 4/587; H01M 10/0525; H01M 10/0562; H01M 10/058; H01M 50/434; H01M 2300/0071

(57) ABSTRACT

The present invention addresses the problem of providing an all-solid-state lithium-ion secondary battery that has excellent charging/discharging characteristics.

The present invention includes at least a negative electrode layer, a separator layer, and a positive electrode layer. The negative electrode layer contains a negative electrode active substance which includes graphite. The separator layer is made of an oxide solid electrolyte. A resistance reduction layer is formed between the negative electrode layer and the separator layer, and the resistance reduction layer is made of a lithium alloy. Alternatively, the present invention includes a substance with which a lithium alloy is formed as a result of a secondary battery operation in which current flows between the negative electrode layer and the positive electrode layer.

### TECHNICAL FIELD

The present invention relates to an all-solid-state lithium-ion secondary battery and a method for producing the same.

### BACKGROUND ART

Large-capacity secondary batteries are used in a wide variety of situations, including electric vehicles including hybrids, energy sources for electronic devices, and power storage equipment for renewable energy such as solar cells. However, in order to realize a low-carbon and smart society, secondary batteries with even higher capacity and better charge/discharge characteristics become necessary.

Lithium-ion secondary batteries have a high energy density and use carbon materials such as graphite for the negative electrode to occlude lithium ions, and use an oxide of lithium and transition metals for the positive electrode, thereby preventing metal deposition during charging and discharging. For this reason, lithium-ion secondary batteries are highly practical and have become the mainstream of large-capacity secondary batteries. As the next generation, all-solid-state lithium-ion secondary batteries are expected to have even greater capacity, safety, and ease of handling.

Lithium-ion secondary batteries using a negative electrode made of graphite include lithium-ion secondary batteries using an organic electrolyte and sulfide-type all-solid-state lithium-ion secondary batteries using a sulfide solid electrolyte.

The organic electrolyte is permeated into the porous graphite negative electrode layer, thereby being able to be bonded to the graphite negative electrode active material particles over a wide reaction area. Furthermore, in the case of a sulfide solid electrolyte, by cold pressing a mixture of solid electrolyte particles and graphite negative electrode active material particles, the bonding between the electrolyte particles and the bonding between the electrolyte and the active material particles can be easily achieved.

In contrast, oxide-type all-solid-state lithium-ion secondary batteries, which have high atmospheric stability, are prepared by high-temperature sintering to bond between solid electrolyte particles and to bond between the solid electrolyte and active material particles, as disclosed in “Patent Literature 1” and “Non Patent Literature 1”. However, since graphite with a low sinterability is difficult to sinter, it is necessary to bond the solid electrolyte and the active material particles by the use of other methods of compression bonding and so on, and thus it difficult to make a negative electrode with low resistance that can operate at room temperature. A negative electrode with high resistance increases the internal resistance of the battery and give bad influence on charge/discharge characteristics of the battery.

### CITATION LIST

### Patent Literature

PATENT LITERATURE 1: JP 6686945 B
PATENT LITERATURE 2: JP 6748035 B

### Non Patent Literature

NON PATENT LITERATURE 1: Martin Finsterbusch, Timo Danner, Chin-Long Tsai, Sven Uhlenbruck, Arnulf Latz, and Olivier Guillon, ACS Appl. Mater. Interfaces 2018, 10, 22329-22339.
NON PATENT LITERATURE 2: Narumi Ohta, Shin Kimura, Junichi Sakabe, Kazutaka Mitsuishi, Tsuyoshi Ohnishi, and Kazunori Takada, ACS Appl. Energy Mater. 2019, 2, 7005-7008.

### SUMMARY OF INVENTION

### Technical Problem

An object of the present invention is to provide an all-solid-state lithium-ion secondary battery with excellent charge/discharge characteristics and a method for producing the same.

### Solution to Problem

The present invention for solving the problems has, as aspects thereof, each configuration shown below.

### (Configuration 1)

An all-solid-state lithium-ion secondary battery comprising at least a negative electrode layer, a separator layer, and a positive electrode layer, wherein:
the negative electrode layer contains a negative electrode active material containing graphite;
the separator layer contains an oxide solid electrolyte; and
a low-resistance layer is formed between the negative electrode layer and the separator layer,
wherein the low-resistance layer is made of a lithium alloy or contains a material that forms a lithium alloy by performing a secondary battery operation that causes a current to flow between the negative electrode layer and the positive electrode layer.

### (Configuration 2)

The all-solid-state lithium-ion secondary battery according to Configuration 1, wherein the low-resistance layer contains one or more elements selected from the group consisting of gold, silver, platinum, aluminum, tin, indium, germanium, lead, zinc, antimony, magnesium, silicon, cadmium, gallium, tellurium, and bismuth.

### (Configuration 3)

The all-solid-state lithium-ion secondary battery according to Configuration 1, wherein the low-resistance layer has a thickness of 1 to 500 nm.

### (Configuration 4)

The all-solid-state lithium-ion secondary battery according to Configuration 1, wherein the low-resistance layer includes one or more selected from the group consisting of gold, silver, platinum, tin, indium, and silicon.

### (Configuration 5)

The all-solid-state lithium-ion secondary battery according to any one of Configurations 1 to 4, wherein the low-resistance layer is disposed in contact with the separator layer.

### (Configuration 6)

The all-solid-state lithium-ion secondary battery according to any one of Configurations 1 to 5, wherein the low-resistance layer is disposed in contact with the negative electrode layer.

### (Configuration 7)

The all-solid-state lithium-ion secondary battery according to any one of Configurations 1 to 6, in which the solid electrolyte contained in the separator layer has a garnet-type crystal structure with high ionic conductivity or a garnet-type-like crystal structure with high ionic conductivity.

### (Configuration 8)

The all-solid-state lithium-ion secondary battery according to any one of Configurations 1 to 7, wherein the solid electrolyte contained in the separator layer is made of a composite oxide containing Li and one or more selected from the group consisting of a ceramic having a garnet-type structure, a ceramic having a perovskite-type structure, and a ceramic having a LISICON-type structure.

### (Configuration 9)

The all-solid-state lithium-ion secondary battery according to any one of Configurations 1 to 8, in which the negative electrode active material is made of graphite.

### (Configuration 10)

The all-solid-state lithium-ion secondary battery according to any one of Configurations 1 to 9, wherein the negative electrode active material contains graphite and a material that can occlude less than 10% of lithium ions.

### (Configuration 11)

The all-solid-state lithium-ion secondary batter according to any one of Configurations 1 to 10, wherein:
the positive electrode layer contains a positive electrode active material; and
the positive electrode active material is made of one or more elements selected from the group consisting of a spinel-type lithium-manganese composite oxide represented by LiM¹ₓMn₂₋ₓO₄ (where M¹ is at least one element selected from the group consisting of Li, B, Mg, Ca, Sr, Ba, Ti, V, Cr, Fe, Co, Ni, Cu, Al, Sn, Sb, In, Nb, Mo, W, Y, Ru, and Rh, and 0.01≤x≤0.5), a layered compound represented by LiₓMn_{(1-y-x)}Ni_{y}M²_{z}O₍₂₋ₖ₎Fₗ (where M² is at least one element selected from the group consisting of Co, Mg, Al, B, Ti, V, Cr, Fe, Cu, Zn, Zr, Mo, Sn, Ca, Sr, and W, and 0.8≤x≤1.2, 0<y<0.5, 0≤z≤0.5, k+l<1, −0.1≤k≤0.2, and 0≤l≤0.1), a lithium-cobalt composite oxide represented by LiCo₁₋ₓM³ₓO₂ (where M³ is at least one element selected from the group consisting of Al, Mg, Ti, Zr, Fe, Ni, Cu, Zn, Ga, Ge, Nb, Mo, Sn, Sb, and Ba, and 0≤x≤0.5), a lithium-nickel composite oxide represented by LiNi₁₋ₓM⁴ₓO₂ (where M⁴ is at least one element selected from the group consisting of Al, Mg, Ti, Zr, Fe, Co, Cu, Zn, Ga, Ge, Nb, Mo, Sn, Sb, and Ba, and 0≤x≤0.5), an olivine-type composite oxide represented by LiM⁵₁₋ₓN¹ₓPO₄ (where M⁵ is at least one element selected from the group consisting of Fe, Mn, and Co, N¹ is at least one element selected from the group consisting of Al, Mg, Ti, Zr, Ni, Cu, Zn, Ga, Ge, Nb, Mo, Sn, Sb, and Ba, and 0≤x≤0.5), and a lithium-titanium composite oxide represented by Li₄Ti₅O₁₂.

### (Configuration 12)

A method for producing an all-solid-state lithium-ion secondary battery, the all-solid-state lithium-ion secondary battery according to any one of Configurations 1 to 11, wherein the low-resistance layer is formed by one or more methods selected from the group consisting of a sputtering method, a vapor deposition method, a coating formation method, and a foil bonding method.

### Advantageous Effects of Invention

According to the present invention, an all-solid-state lithium-ion secondary battery with excellent charge/discharge characteristics and a method for producing the same are provided.

### BRIEF DESCRIPTION OF DRAWINGS

FIG. 1 is a structural explanatory diagram showing a cross-sectional view of a configuration of an all-solid-state lithium-ion secondary battery of the present invention.

FIG. 2 is a structural explanatory diagram showing a cross-sectional view of a configuration of an all-solid-state lithium-ion half-cell (which is also hereinafter referred to as a “half-cell”) shown in an embodiment.

FIG. 3 is a characteristic diagram showing initial charging characteristics of the half-cell obtained in “Embodiment 1” (“Example 1”). Here, an explanation thereof is given from the viewpoint of the negative electrode for a whole battery, and thus the reaction of inserting lithium ions into graphite of a test electrode active material is referred to as “charge reaction”, and the reaction of desorbing the lithium ions from the graphite of the test electrode active material is referred to as “discharge reaction”.

FIG. 4 is an alternating current (AC) impedance spectrum diagram after the initial charge of the half-cell obtained in “Embodiment 1” (“Example 1”).

FIG. 5 is a characteristic diagram showing the initial charging characteristics of the half-cell obtained in “Embodiment 2” (“Example 2”).

FIG. 6 is a diagram showing the X-ray diffraction pattern after the initial charge of the half-cell obtained in “Embodiment 2” (“Example 2”).

FIG. 7 is a characteristic diagram showing the initial charge and discharge of the half-cell obtained in “Embodiment 3” (“Example 3”).

FIG. 8 is a characteristic diagram showing the battery capacity versus the number of charge/discharge cycles of the half-cell obtained in “Embodiment 3” (“Example 3”).

FIG. 9 is a characteristic diagram showing the initial charging characteristics of the half-cell obtained in “Embodiment 4” (“Example 4”).

FIG. 10 is an AC impedance spectrum diagram after the initial charge of the half-cell obtained in “Embodiment 4” (“Example 4”).

FIG. 11 is a characteristic diagram showing the initial charging characteristics of the half-cell obtained in “Embodiment 5” (“Example 5”).

FIG. 12 is an AC impedance spectrum diagram after the initial charge of the half-cell obtained in “Embodiment 5” (“Example 5”).

FIG. 13 is a characteristic diagram showing the initial charging characteristics of the half-cell obtained in “Embodiment 6” (“Example 6”).

FIG. 14 is an AC impedance spectrum diagram after the initial charge of the half-cell obtained in “Embodiment 6” (“Example 6”).

FIG. 15 is a characteristic diagram showing the initial charging characteristics of the half-cell obtained in “Embodiment 7” (“Example 7”).

FIG. 16 is an AC impedance spectrum diagram after the initial charge of the half-cell obtained in “Embodiment 7” (“Example 7”).

FIG. 17 is a characteristic diagram showing the initial charging characteristics of the half-cell obtained in “Comparative Example 1” (“Example 8”).

FIG. 18 is an AC impedance spectrum diagram after the initial charge of the half-cell obtained in “Comparative Example 1” (“Example 8”).

FIG. 19 is a characteristic diagram showing the initial charging characteristics of the half-cell obtained in “Example 9” of an embodiment. Here, an explanation thereof is given from the viewpoint of the negative electrode for a whole battery, and thus the reaction of inserting lithium ions into graphite of a test electrode active material is referred to as “charge reaction”, and the reaction of desorbing the lithium ions from the graphite of the test electrode active material is referred to as “discharge reaction”.

FIG. 20 is an AC impedance spectrum diagram after the initial charge of the half-cell obtained in “Example 9” of an embodiment.

FIG. 21 is a diagram showing the X-ray diffraction pattern after the initial charge of the half-cell obtained in “Example 9” of an embodiment.

FIG. 22 is a characteristic diagram showing the initial charging characteristics of the half-cell obtained in “Example 10” of an embodiment.

FIG. 23 is an AC impedance spectrum diagram after the initial charge of the half-cell obtained in “Example 10” of an embodiment.

FIG. 24 is a characteristic diagram showing the initial charging characteristics of the half-cell obtained in “Example 11” of an embodiment.

FIG. 25 is an AC impedance spectrum diagram after the initial charge of the half-cell obtained in “Example 11” of an embodiment.

FIG. 26 is a characteristic diagram showing the initial charging characteristics of the half-cell obtained in “Example 12” of an embodiment.

FIG. 27 is an AC impedance spectrum diagram after the initial charge of the half-cell obtained in “Example 12” of an embodiment.

FIG. 28 is a characteristic diagram showing the initial charging characteristics of the half-cell obtained in “Example 13” of an embodiment.

FIG. 29 is an AC impedance spectrum diagram after the initial charge of the half-cell obtained in “Example 13” of an embodiment.

FIG. 30 is a characteristic diagram showing the initial charging characteristics of the half-cell obtained in “Example 14” of an embodiment.

FIG. 31 is an AC impedance spectrum diagram after the initial charge of the half-cell obtained in “Example 14” of an embodiment.

FIG. 32 is a characteristic diagram showing the initial charging characteristics of the half-cell obtained in “Example 15” of an embodiment.

FIG. 33 is an AC impedance spectrum diagram after the initial charge of the half-cell obtained in “Example 15” of an embodiment.

FIG. 34 is a characteristic diagram showing the initial charging characteristics of the half-cell obtained in “Example 16” of an embodiment.

FIG. 35 is an AC impedance spectrum diagram after the initial charge of the half-cell obtained in “Example 16” of an embodiment.

FIG. 36 is a characteristic diagram showing the initial charging characteristics of the half-cell obtained in “Example 17” of an embodiment.

FIG. 37 is an AC impedance spectrum diagram after the initial charge of the half-cell obtained in “Example 17” of an embodiment.

FIG. 38 is a characteristic diagram showing the initial charging characteristics of the half-cell obtained in “Example 18” of an embodiment.

FIG. 39 is an AC impedance spectrum diagram after the initial charge of the half-cell obtained in “Example 18” of an embodiment.

FIG. 40 is a diagram showing the X-ray diffraction pattern after the initial charge of the half-cell obtained in “Example 18” of an embodiment.

FIG. 41 is a diagram showing element distribution in a depth direction of the negative electrode layer obtained in “Example 19” of an embodiment. In the Fig., the horizontal axis shows sputtering time (seconds), and the vertical axis shows intensity.

FIG. 42 is a diagram showing element distribution in a depth direction of the negative electrode layer obtained in “Example 20” of an embodiment. In the Fig., the horizontal axis shows sputtering time (seconds), and the vertical axis shows intensity.

### DESCRIPTION OF EMBODIMENTS

Embodiments for carrying out the present invention will be described below with reference to the drawings. Additionally, the expression “A to B” in the text represents values equal to or greater than “A” and equal to or less than “B”.

### <Structure of Battery>

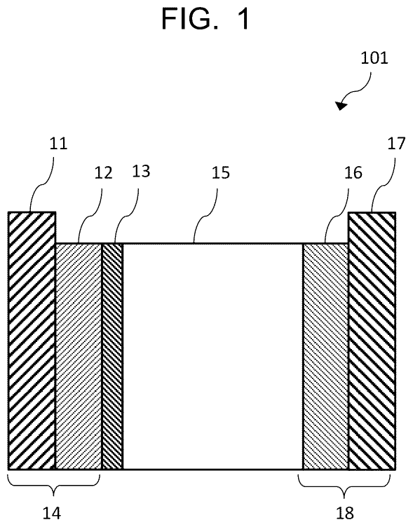

As shown in FIG. 1, an all-solid-state lithium-ion secondary battery 101, which is an embodiment of the present invention, includes a negative electrode current collector 11, a negative electrode active material layer 12, a low-resistance layer 13, a separator layer 15, a positive electrode active material layer 16, and a positive electrode current collector 17. Here, the negative electrode current collector 11 and the negative electrode active material layer 12 constitute a negative electrode (i.e., a negative electrode layer) 14, and the positive electrode active material layer 16 and the positive electrode current collector 17 constitute a positive electrode (i.e., a positive electrode layer) 18. It should be noted that the negative electrode active material layer 12 and the negative electrode current collector 11 may not be separated from each other and the negative electrode active material layer 12 that also functions as the negative electrode current collector 11 may constitute, in a solo, a negative electrode. Additionally, it should be noted that the positive electrode active material layer 16 and the positive electrode current collector 17 may not be separated from each other, and the positive electrode active material layer 16 that also functions as the positive electrode current collector 17 may constitute, in a solo, a positive electrode.

The negative electrode current collector 11 and the positive electrode current collector 17 (both of which are also hereinafter collectively referred to as “current collectors”) are electrodes intended to give functions to mediate the movement of electrons from one surface in contact with the positive electrode active material layer 16 (i.e., surface where the positive electrode current collector 17 is in contact with the positive electrode active material layer 16 according to FIG. 1) to the other surface in contact with the negative electrode active material layer 12 (i.e., surface where the negative electrode current collector 11 is in contact with the negative electrode active material layer 12 according to FIG. 1), and there are no particular limitations on the material used, as long as the material has conductivity, and metals or conductive resins can be used.

Specifically, examples of the electrode include an electrode having a metal selected from the group consisting of copper (Cu), tungsten (W), aluminum (Al), nickel (Ni), iron (Fe), titanium (Ti), gold (Au), silver (Ag), platinum (Pt), and palladium (Pd). That is, the negative electrode current collector 11 and the positive electrode current collector 17 can be electrodes made of a single metal selected from the above group, an alloy containing a metal selected from the above group, or a compound of a metal selected from the above group with carbon (C), nitrogen (N) or the like. The foil may be stainless steel or a foil having a metal surface coated with aluminum. Among these, aluminum, stainless steel, copper, and nickel can be preferably used from the viewpoints of electron conductivity, battery operating potential, application of a cost-effective and easy-to-handle sputtering method, and so on.

As the conductive resin, a non-conductive polymer material to which a conductive filler is added can be preferably used. Here, examples of non-conductive polymer material include polyethylene (PE), polypropylene (PP), polyethylene terephthalate (PET), polyethernitrile (PEN), polyimide (PI), polyamide (PA), polytetrafluoroethylene (PTFE), styrene-butadiene rubber (SBR), polyacrylonitrile (PAN), polymethyl acrylate (PMA), polymethyl methacrylate (PMMA), polyvinyl chloride (PVC), polyvinylidene fluoride (PVdF), and polystyrene (PS). Additionally, examples of the conductive filler can include one or more metals selected from the group consisting of nickel (Ni), titanium (Ti), aluminum (Al), copper (Cu), platinum (Pt), chromium (Cr), iron (Fe), zinc (Zn), tin (Sn), indium (In), and antimony (Sb), alloys containing these metals, metal compounds containing these metals, or one or more selected from the group consisting of acetylene black, carbon nanofibers, carbon nanotubes, carbon nanohorns, carbon nanoballoons, and fullerenes.

The negative electrode active material layer 12 is preferably made of graphite or a material containing graphite as a main component, and more preferably made of a material containing graphite as a main component. The negative electrode active material layer 12 is preferably made of graphite. The graphite is also superior in terms of increasing battery energy density, ease of production, and cost reduction.

Here, the phrase “containing graphite as a main component” means containing graphite in a molar ratio of 90% or more and less than 100%. The material added to the graphite is a material capable of occluding lithium ions (that is, a material that can occlude lithium ions), and includes, for example, a material containing silicon or tin. An example of a case where the negative electrode active material layer 12 is made of the graphite and the silicon is a case where the molar ratio is 95% graphite and 5% silicon.

The low-resistance layer 13 is a layer made of a material containing a metal capable of being alloyed with lithium (Li) (that is, a metal that can be alloyed). For example, the low-resistance layer 13 is a layer made of a lithium alloy, or a layer that becomes a lithium alloy due to secondary battery operation (i.e., charge/discharge operation), and the presence of the low-resistance layer 13 enables the electrical resistance between the negative electrode active material layer 12 and the separator layer 15 (at the interface in a case where the two are in contact) to reduce. When the electrical resistance between the negative electrode active material layer 12 and the separator layer 15 is reduced, the internal resistance of the secondary battery is also reduced, the charge/discharge characteristics thereof are improved, and the electric capacity thereof is also increased.

Examples of specific materials for the low-resistance layer 13 include materials containing one or more elements selected from the group consisting of gold (Au), silver (Ag), platinum (Pt), aluminum (Al), tin (Sn), indium (In), germanium (Ge), lead (Pb), zinc (Zn), antimony (Sb), magnesium (Mg), silicon (Si), cadmium (Cd), gallium (Ga), tellurium (Te), and bismuth (Bi), and in particular, one or more elements selected from the group consisting of gold, silver, platinum, tin, indium, and silicon are preferably used from the viewpoint of stability and ease of handling.

Furthermore, the shape of a material of the low-resistance layer 13 (specifically, a material containing one or more elements selected from the group consisting of gold (Au), silver (Ag), platinum (Pt), aluminum (Al), tin (Sn), indium (In), germanium (Ge), lead (Pb), zinc (Zn), antimony (Sb), magnesium (Mg), silicon (Si), cadmium (Cd), gallium (Ga), tellurium (Te), and bismuth (Bi), and particularly preferably one or more elements selected from the group consisting of gold, silver, platinum, tin, indium and silicon) may be in contact with the separator layer 15 so that the effects of the present invention can be achieved. Therefore, as long as the above material is in contact with the separator layer 15 so that the effects of the present invention can be achieved, the shape thereof is not limited to being a layered shape (specifically, a shape in which the particles of the above material are continuously aligned and fixed to each other on the separator layer 15, thereby forming a sheet-like thin film in contact with the above separator layer), but may also be a shape in which, for example, the particles of the above material are discontinuously aligned and fixed to each other on the separator layer 15, thereby adhering to the above separator layer. The shape of the low-resistance layer 13 is preferably a layered shape. This is because in the case where the shape of the above low-resistance layer is a layered shape, the contact area between the separator layer 15 and the negative electrode layer 14 can be increased during charge and discharge operations, and the resistance of the interface between these is reduced, thereby improving the charge/discharge characteristics. Also, when a thickness of the above low-resistance layer of the case of the layered shape is calculated from the weight of the above material used, the thickness is preferably 1 to 500 nm. The thickness thereof is more preferably from 5 to 300 nm, and even more preferably from 10 to 260 nm. When the thickness thereof is extremely thin, a continuous film of the layered shape will not be formed, and when the thickness thereof is extremely thick, material costs and process costs will increase, and thus the thickness thereof is preferably within the above range.

The low-resistance layer 13 is preferably disposed in contact with the separator layer 15, and is preferably disposed in contact with the negative electrode layer 14, particularly the negative electrode active material layer 12. This is because when the low-resistance layer 13 is in contact with these layers, the resistance thereof is lowered, and this contact further increases the reliability and stability of the secondary battery operation.

As a method for forming the low-resistance layer 13, one or more methods selected from the group consisting of a sputtering method, a vapor deposition method such as electron beam vapor deposition or thermal vapor deposition, a coating formation method, and a foil bonding method can be listed. The sputtering method and the vapor deposition method are methods that are often used industrially, and the coating formation method and the foil bonding method are easy-to-handle methods because these methods do not require a vacuum environment. The low-resistance layer 13 is intended to lower the resistance of the entire interface thereof, and thus has a high tolerance to localized defects such as pinholes (in other words, the low-resistance layer 13 is less susceptible to the defects.). Therefore, a low-cost method such as a foil bonding method can be applied to the low-resistance layer 13.

The separator layer 15 is a layer having a separator function for an all-solid-state lithium-ion secondary battery, and contains an oxide solid electrolyte or is made of an oxide solid electrolyte.

As the oxide solid electrolyte, the electrolyte having a garnet-type crystal structure with high ionic conductivity or a garnet-type-like crystal structure with high ionic conductivity can be listed. Examples of specific materials thereof include Li₇La₃Zr₂O₁₂, Li₇₋ₓLa₃Zr₂₋ₓTaₓO₁₂ (where x is 0 or more and 2 or less), Li₇₋₃ₓLa₃Zr₂AlₓO₁₂ (where x is 0 or more and 0.5 or less), Li₇₋ₓLa₃Zr₂₋ₓNbₓO₁₂ (where x is 0 or more and 2 or less), and Li_{7-x-3y}La₃Zr₂₋ₓTaₓAl_{y}O₁₂ (where x is 0 or more and 2 or less, and y is 0 or more and 0.5 or less).

As a solid electrolyte contained in the separator layer 15, a composite oxide containing lithium (Li) and one or more selected from the group consisting of a ceramic having a garnet-type structure, a ceramic having a perovskite-type structure, and a ceramic having a LISICON-type structure can be also listed. Examples of specific materials thereof include LISICON, NASICON, PEO, LIPON, PVDF, Li₃N, Li₃P, LiI, LiBr, LiCl, LiF, Li_{0.5}TiO₃, Li₂S—SiS₂—Li₃PO₄, lithium nitride, doped Li₃N, Li₂S—SiS₂—Li₃PO₄, Li₁₄Zn(GeO₄)₄, Li-β-alumina, Li_{3.6}Si_{0.6}P_{0.4}O₄, PEO-LiClO₄, LiN(CF₃SO₂)₂/(CH₂CH₂O)₈, Li₇La₃Zr₂O₁₂ with one or more added elements selected from the group consisting of Al, Ga, Nb, Ta, Ca, and Sr, and Li₃BO₃ can be listed.

The positive electrode active material layer 16 is not particularly limited as long as the positive electrode active material layer 16 is a positive electrode active material containing lithium, but typically, a lithium-containing composite metal oxide can be listed.

As a specific material of the positive electrode active material layer 16, one or more elements selected from the group consisting of a spinel-type lithium-manganese composite oxide represented by LiM¹ₓMn₂₋ₓO₄ (where M¹ is at least one element selected from the group consisting of Li, B, Mg, Ca, Sr, Ba, Ti, V, Cr, Fe, Co, Ni, Cu, Al, Sn, Sb, In, Nb, Mo, W, Y, Ru, and Rh, and 0.01≤x≤0.5), a layered compound represented by LiₓMn_{(1-y-x)}Ni_{y}M²_{z}O₍₂₋ₖ₎Fₗ (where M² is at least one element selected from the group consisting of Co, Mg, Al, B, Ti, V, Cr, Fe, Cu, Zn, Zr, Mo, Sn, Ca, Sr, and W, and 0.8≤x≤1.2, 0<y<0.5, 0≤z≤0.5, k+l<1, −0.1≤k≤0.2, and 0≤l≤0.1), a lithium-cobalt composite oxide represented by LiCo₁₋ₓM³ₓO₂ (where M³ is at least one element selected from the group consisting of Al, Mg, Ti, Zr, Fe, Ni, Cu, Zn, Ga, Ge, Nb, Mo, Sn, Sb, and Ba, and 0≤x≤0.5), a lithium-nickel composite oxide represented by LiNi₁₋ₓM⁴ₓO₂ (where M⁴ is at least one element selected from the group consisting of Al, Mg, Ti, Zr, Fe, Co, Cu, Zn, Ga, Ge, Nb, Mo, Sn, Sb, and Ba, and 0≤x≤0.5), an olivine-type composite oxide represented by LiM⁵₁₋ₓN¹ₓPO₄ (where M⁵ is at least one element selected from the group consisting of Fe, Mn, and Co, N¹ is at least one element selected from the group consisting of Al, Mg, Ti, Zr, Ni, Cu, Zn, Ga, Ge, Nb, Mo, Sn, Sb, and Ba, and 0≤x≤0.5), and a lithium-titanium composite oxide represented by Li₄Ti₅O₁₂ can be listed.

According to the battery having the structure described above, as the all-solid-state lithium-ion secondary battery according to one embodiment of the present invention, the all-solid-state lithium-ion secondary battery 101 with a small internal resistance and excellent charge/discharge characteristics is provided.

### <Battery Production Method>

First, a solid electrolyte obtained by sintering a solid electrolyte material by means of a hot press sintering method or the like is prepared, and this is used as the separator layer 15. The sintering temperature can be, for example, 800° C. or higher and 1,200° C. or lower.

Next, the low-resistance layer 13 is formed on one (i.e., “first main surface”) of the main surfaces of the separator layer 15. As described above, the forming method includes one or more methods selected from the group consisting of a sputtering method, a vapor deposition method such as electron beam vapor deposition or thermal vapor deposition, a coating formation method, and a foil bonding method. It should be noted that in the present application, the main surface of the separator layer means the surface that is in contact with the low-resistance layer, the positive electrode active material layer, or the counter electrode.

Thereafter, the positive electrode current collector 17 on which the positive electrode active material layer 16 is deposited, and the negative electrode current collector 11 on which the negative electrode active material layer 12 is deposited are prepared. As each material for the positive electrode active material layer 16, the positive electrode current collector 17, the negative electrode active material layer 12, and the negative electrode current collector 11, the materials described in the above section on the battery structure of the present application can be used. Examples of the deposition method include a bonding method, a sputtering method, a vapor deposition method, a chemical vapor deposition (CVD) method, a spray coating method, a blade coating method, a slit die coating method, and a roll coating method.

Thereafter, the negative electrode current collector 11 on which the negative electrode active material layer 12 is deposed and the separator layer 15 in the direction where the negative electrode active material layer 12 is in contact with the low-resistance layer 13 are disposed on the low-resistance layer 13. Furthermore, the positive electrode current collector 17 on which the positive electrode active material layer 16 is deposited is disposed on a main surface (, which is referred to as the “second main surface” in the present application to be distinguished from the first main surface) of the separator layer 15 opposite to the first main surface on which the low-resistance layer 13 is disposed. The negative electrode current collector 11, the negative electrode active material layer 12, the low-resistance layer 13, the separator layer 15, the positive electrode active material layer 16, and the positive electrode current collector 17 are bundled and compression-bonded, and then the bundle is placed in a housing (not shown) to produce the all-solid-state lithium-ion secondary battery 101 (see FIG. 1).

By the production method described above, the all-solid-state lithium-ion secondary battery 101 having the above structure can be provided. Additionally, the all-solid-state lithium-ion secondary battery 101 has the characteristics of low internal resistance and excellent charge/discharge characteristics.

### EMBODIMENTS

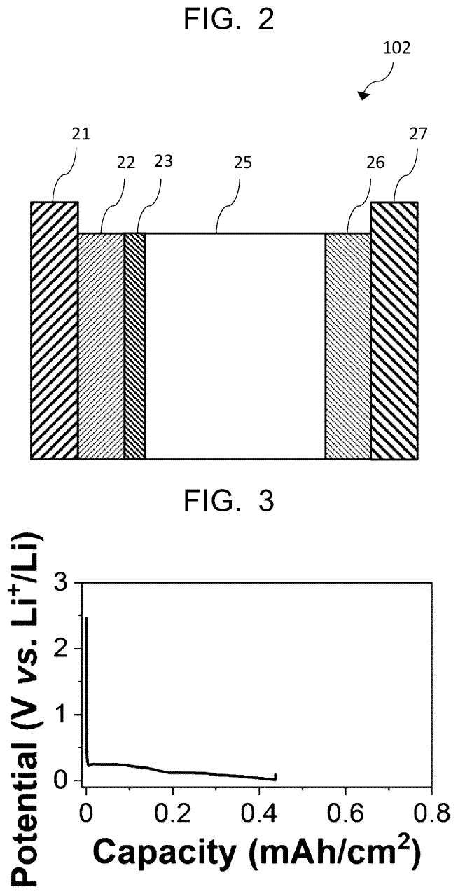

In the embodiments of the present application, for the purpose of eliminating the influence of the positive electrode that is used in the all-solid-state lithium-ion secondary battery and investigating the interface bonding due to the graphite negative electrode active material alone, an all-solid-state lithium-ion half-cell 102 (see FIG. 2) was prepared by using graphite as the test electrode 22, a LiLaZrTaO sintered body as the separator layer 25, and a lithium foil as the counter electrode 26, and the characteristics thereof were evaluated. Samples prepared here are eight types shown in “Embodiments 1 to 7” and “Comparative Example 1”. The low-resistance layer 23 is made of gold (Au) in “Embodiments 1 to 3”, indium (In) in “Embodiment 4”, silver (Ag) in “Embodiment 5”, platinum (Pt) in “Embodiment 6”, and silicon (Si) in “Embodiment 7”, and in “Comparative Example 1”, the low-resistance layer 23 is not disposed.

Here, the method for preparing the samples will first be summarized, followed by a summary of the characteristics thereof. It should be noted that in this application, embodiments and comparative examples may be also referred to as “Examples” simply, for convenience. In this case, “Embodiments 1 to 7” will be referred to as “Examples 1 to 7”, and “Comparative Example 1” will be referred to as “Example 8”.

### Sample Preparation

### Embodiment 1 (Example 1)

### (Solid Electrolyte)

As the separator layer 25 (i.e., solid electrolyte), a sintered body of Li_{6.6}La₃Zr_{1.6}Ta_{0.4}O₁₂ (manufactured by Toshima Manufacturing Co., Ltd.) having a diameter of 10 mm and a thickness of 2 mm was used.

### (Graphite Dispersion Liquid)

As a graphite dispersion liquid, the dispersion liquid in which graphite powders (manufactured by IMERYS S.A., KS6, average diameter 4.4 μm) of 450 mg were dispersed in 99.5% ethanol (manufactured by FUJIFILM Wako Pure Chemical Corporation) of 30 g was used.

### (Preparation Step)

First, the graphite dispersion liquid was spray-coated on an unpolished SUS304 disk having a diameter of 10 mm and a thickness of 0.5 mm by means of a small spray coating device (manufactured by ACing Technologies Co., Ltd., model AV-8), thereby obtaining the test electrode 22 that was made of the graphite of which a coating amount was 1.77 mg/cm².

Next, by means of a compact sputtering device (manufactured by Sanyu Industries Co., Ltd., SC-701MkII ADVANCE), a gold (Au) layer having a weight of 0.29 mg/cm² was formed on each of the main surfaces of the solid electrolyte sintered body (diameter 10 mm, thickness 2 mm) that forms the separator layer 25. Here, the gold layer on the side in contact with the test electrode 22 corresponds to the low-resistance layer 23.

Thereafter, a 50 μm-thick lithium (Li) foil (manufactured by Honjo Chemical Corporation) was prepared as the counter electrode 26, and the lithium foil was disposed on one surface of the solid electrolyte 25 coated with a gold layer. Subsequently, the test electrode 22 made of the graphite was disposed on the other surface of the solid electrolyte 25 coated with a gold layer that became to be the low-resistance layer 23.

After then, a primary assembly was obtained by combining: the test electrode 22 made of the graphite; the solid electrolyte 25, both surfaces of which were coated with a gold layer; and the counter electrode 26 (specifically, Li foil). Also, in “Embodiment 1” (“Example 1”), the SUS304 used in the spray-coated substrate was used as the current collector 21, and an unpolished SUS304 disk having a diameter of 10 mm and a thickness of 0.5 mm was newly used as the current collector 27 and was disposed on one surface of the counter electrode 26 (i.e., Li foil).

### (Pressurizing Step)

The half-cell 102 of “Embodiment 1” was obtained by screw-tightening the obtained primary assembly with a torque of 2.0 Nm and applying a confining pressure of 40 MPa in the stacking direction.

### Embodiment 2 (Example 2) and Embodiment 3 (Example 3)

The half-cells 102 of “Embodiment 2” (“Example 2”) and “Embodiment 3” (“Example 3”) were obtained in the same manner as in “Embodiment 1” (“Example 1”) except that the coating amount of the graphite powders in “Embodiment 1” (“Example 1”) was changed as shown in Table 1.

TABLE 1

| | Graphite Layer |
|---|---|
| Embodiment 1 (Example 1) | 1.177 mg/cm² |
| Embodiment 2 (Example 2) | 1.368 mg/cm² |
| Embodiment 3 (Example 3) | 1.307 mg/cm² |
| Embodiment 4 (Example 4) | 1.206 mg/cm² |
| Embodiment 5 (Example 5) | 1.239 mg/cm² |
| Embodiment 6 (Example 6) | 1.203 mg/cm² |
| Embodiment 7 (Example 7) | 1.394 mg/cm² |
| Comparative Example 1 (Example 8) | 1.050 mg/cm² |

### Embodiment 4 (Example 4)

The half-cell 102 of “Embodiment 4” (“Example 4”) was obtained in the same manner as in “Embodiment 1” (“Example 1”) except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with an indium (In) layer having a weight of 0.17 mg/cm²; and the coating amount of the graphite powders was changed as shown in Table 1. Therefore, the low-resistance layer 23 of “Embodiment 4” (“Example 4”) is formed of an indium layer.

### Embodiment 5 (Example 5)

The half-cell 102 of “Embodiment 5” (“Example 5”) was obtained in the same manner as in “Embodiment 1” (“Example 1”) except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with a silver (Ag) layer having a weight of 0.27 mg/cm²; and the coating amount of the graphite powders was changed as shown in Table 1. Therefore, the low-resistance layer 23 of “Embodiment 5” (“Example 5”) is formed of a silver layer.

### Embodiment 6 (Example 6)

The half-cell 102 of “Embodiment 6” (“Example 6”) was obtained in the same manner as in “Embodiment 1” (“Example 1”) except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with a platinum (Pt) layer having a weight of 0.41 mg/cm²; and the coating amount of the graphite powders was changed as shown in Table 1. Therefore, the low-resistance layer 23 of “Embodiment 6” (“Example 6”) is formed of a platinum layer.

### Embodiment 7 (Example 7)

The half-cell 102 of “Embodiment 7” (“Example 7”) was obtained in the same manner as in “Embodiment 1” (“Example 1”) except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with a silicon layer having a weight of 0.06 mg/cm²; and the coating amount of the graphite powders was changed as shown in Table 1. Therefore, the low-resistance layer 23 of “Embodiment 7” (“Example 7”) is formed of a silicon layer.

### Comparative Example 1 (Example 8)

A half-cell of “Comparative Example 1” (“Example 8”) was obtained in the same manner as in “Embodiment 1” (“Example 1”) except that only one surface of the sintered body 25 of the solid electrolyte on which the counter electrode 26 was disposed was coated with a gold layer and the coating amount of the graphite powders was changed as shown in Table 1. Therefore, “Comparative Example 1” (“Example 8”) does not have the low-resistance layer 23.

### [Characteristics Evaluation]

### (Initial Charge Test)

By using the half-cells obtained in “Embodiment 1” (“Example 1”), “Embodiment 2” (“Example 2”), “Embodiments 4 to 6” (“Examples 4 to 6”), and “Comparative Example 1” (“Example 8”), a CC charge test was performed at a current value of 0.05 C until the voltage reached 0.01 V based on lithium metal.

The initial charge curves obtained as a result of the test are shown in FIGS. 3, 5, 9, 11, 13, and 17, respectively.

Additionally, by using the half-cell obtained in “Embodiment 7” (“Example 7”), CC charging was continuously performed at current values of 0.0005 C for 12 hours and 0.005° C. for 10 hours, and then CC charging was performed at a current value of 0.05 C until the voltage reached 0 V based on lithium metal. Subsequently, a CV charge test was continuously performed at 0 V for 10 hours. The initial charge curve obtained from the test results is shown in FIG. 15. Here, the test environment is a room temperature argon atmosphere at approximately 25° C. under atmospheric pressure.

### (Initial Charge Test Results)

The test results of the initial charge capacity are shown in Table 2.

TABLE 2

| | Test | | |
|---|---|---|---|
| | Electrode | | |
| | Active | Low-Resistance | Charge Capacity |
| | Material | Layer | (mAh/cm²) |
| Embodiment 1 | Graphite | Gold | 0.437 |
| (Example 1) | | | |
| Embodiment 2 | Graphite | Gold | 0.503 |
| (Example 2) | | | |
| Embodiment 3 | Graphite | Gold | 0.410 |
| (Example 3) | | | |
| Embodiment 4 | Graphite | Indium | 0.331 |
| (Example 4) | | | |
| Embodiment 5 | Graphite | Silver | 0.360 |
| (Example 5) | | | |
| Embodiment 6 | Graphite | Platinum | 0.325 |
| (Example 6) | | | |
| Embodiment 7 | Graphite | Silicon | 0.611 |
| (Example 7) | | | |
| Comparative | Graphite | — | 0.109 |
| Example 1 | | | |
| (Example 8) | | | |

The weight of the graphite contained in the test electrode 22 that was made of the graphite and that was incorporated into each of the half-cells obtained in “Embodiment 1” (“Example 1”), “Embodiment 2” (“Example 2”), and “Comparative Example 1” (“Example 8”) is approximately 1 mg/cm² and is almost the same in all cases. However, in “Embodiment 1” (“Example 1”) and “Embodiment 2” (“Example 2”), each of which disposed the test electrode 22 made of the graphite on the surface of the solid electrolyte 25 that was coated with a gold layer of the low-resistance layer 23, a charge capacity larger by approximately 0.3 to 0.4 mAh/cm² was obtained compared to “Comparative Example 1” (“Example 8”) that disposed the test electrode 22 made of the graphite on the surface of the solid electrolyte 25 that was not coated with a gold layer (i.e., “Comparative Example 1” (“Example 8”) in which no low-resistance layer 23 was disposed).

The weight of the graphite contained in the test electrode 22 that was made of the graphite and that was incorporated into each of the half-cells obtained in “Embodiment 4” (“Example 4”), “Embodiment 5” (“Example 5”), “Embodiment 6” (“Example 6”), and “Comparative Example 1” (“Example 8”) were also almost the same in all cases. However, in “Embodiment 4” (“Example 4”), “Embodiment 5” (“Example 5”), and “Embodiment 6” (“Example 6”), each of which disposed the test electrodes 22 made of the graphite on the surface of the solid electrolyte 25 that was coated with an indium layer, a silver layer, or a platinum layer, a charge capacity larger by approximately 0.2 to 0.3 mAh/cm² was obtained compared to “Comparative Example 1” (“Example 8”) that disposed the test electrodes 22 made of the graphite on the surfaces of the solid electrolyte 25 that was not coated with any of the above layers. That is, even when an indium layer, a silver layer, or a platinum layer was disposed as the low-resistance layer 23, a large charge capacity of approximately 0.2 to 0.3 mAh/cm² was obtained compared to the case where no low-resistance layer 23 was disposed.

Furthermore, the weight of the graphite contained in the test electrode 22 that was made of the graphite and that was incorporated into each of the half-cells obtained in “Embodiment 7” (“Example 7”) and “Comparative Example 1” (“Example 8”) is also almost the same in all cases. However, in “Embodiment 7” (“Example 7”) that disposed the test electrode 22 made of the graphite on the surface of the solid electrolyte 25 that was coated with a silicon layer of the low-resistance layer 23, CC charging was performed until the voltage reached 0 V based on lithium metal, and CV charging was further performed for 10 hours, a charge capacity larger by approximately 0.5 mAh/cm² was obtained compared to “Comparative Example 1” (“Example 8”) that disposed the test electrode 22 made of the graphite on the surface of the solid electrolyte 25 that was not coated with a silicon layer, and CC charging was performed until the voltage reached 0 V based on lithium metal, that is, “Comparative Example 1” (“Example 8”) in which no low-resistance layer 23 was disposed.

### (AC Impedance Measurement Method After Initial Charge Test)

After the above initial charge tests were performed by using each of the half-cells obtained in “Embodiment 1” (“Example 1”), “Embodiment 4 (“Example 4”), “Embodiment 5 (“Example 5”), “Embodiment 6” (“Example 6”), “Embodiment 7 (“Example 7”), and “Comparative Example 1” (“Example 8”), AC impedance thereof was measured in the frequency range from 10 mHz to 1 MHz with an applied AC voltage of 10 mV based on the natural potential.

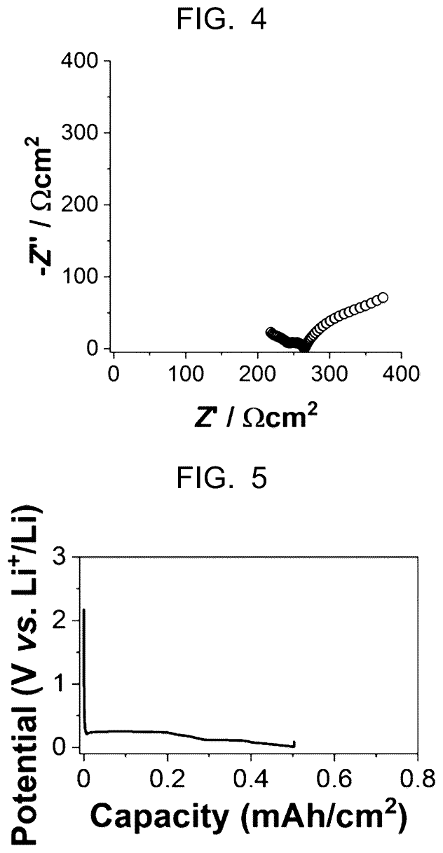

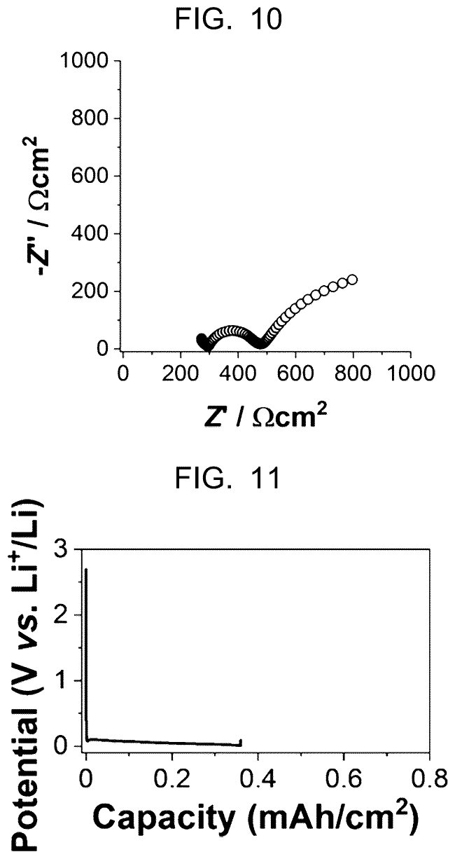

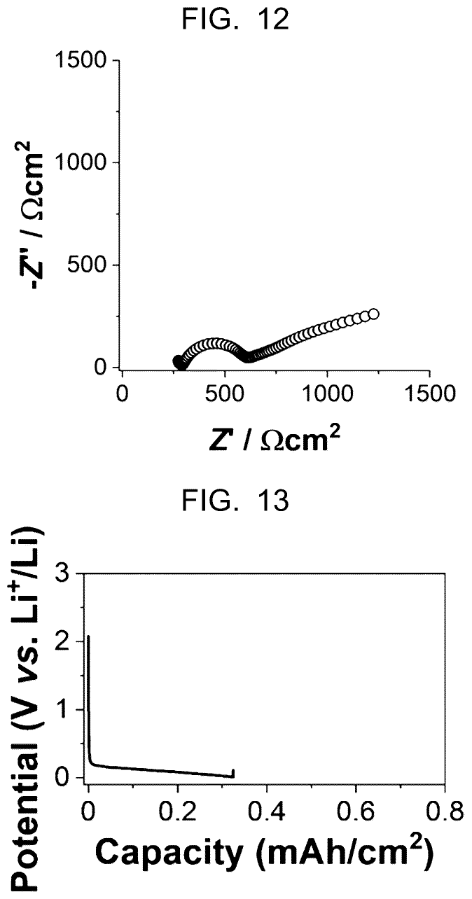

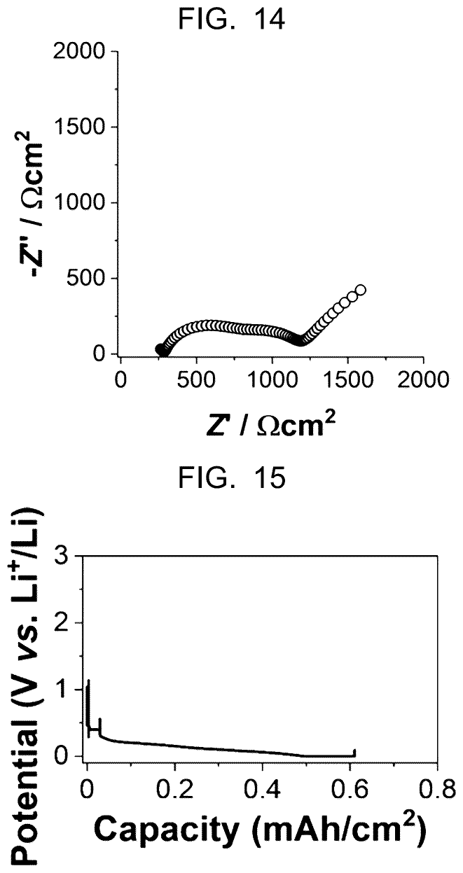

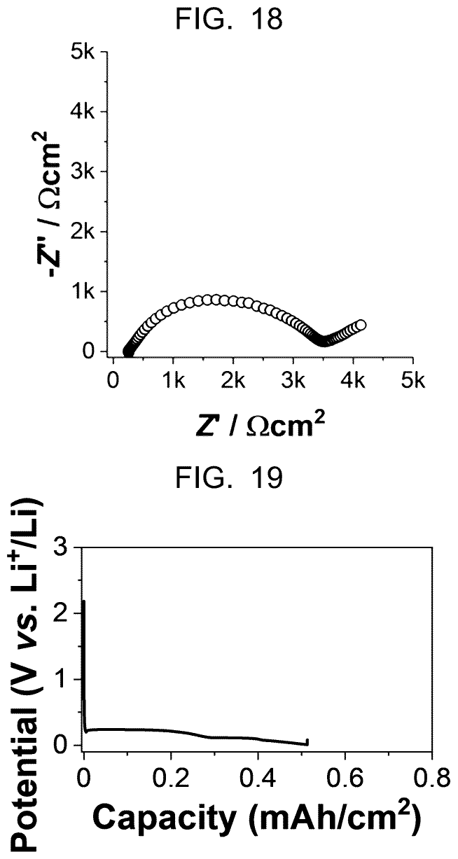

The AC impedance spectra obtained as test results thereof are shown in FIGS. 4, 10, 12, 14, 16, and 18, respectively. Here, the test environment is a room temperature argon atmosphere at approximately 25° C. under atmospheric pressure.

### (AC Impedance Measurement Results After Initial Charge Test)

Table 3 shows the AC impedance measurement results after the initial charge test.

TABLE 3

| | Test | | |
|---|---|---|---|
| | Electrode | Low- | Interfacial Resistance |
| | Active | Resistance | After Initial Charge |
| | Material | Layer | (Ω · cm²) |
| Embodiment 1 | Graphite | Gold | 31 |
| (Example 1) | | | |
| Embodiment 4 | Graphite | Indium | 180 |
| (Example 4) | | | |
| Embodiment 5 | Graphite | Silver | 330 |
| (Example 5) | | | |
| Embodiment 6 | Graphite | Platinum | 955 |
| (Example 6) | | | |
| Embodiment 7 | Graphite | Silicon | 67 |
| (Example 7) | | | |
| Comparative | Graphite | — | 3,188 |
| Example 1 | | | |
| (Example 8) | | | |

From the AC impedance spectra obtained after performing the initial charges of the half-cells obtained in “Embodiment 1” (“Example 1”) and “Comparative Example 1” (“Example 8”), it has been found that in the structure that does not sandwich a gold layer, the interfacial resistance of the test electrode 22 constituted by the solid electrolyte separator layer 25 and the graphite is 3188 Ω·cm², whereas in a structure that sandwiches the low-resistance layer 23 constituted by the gold layer, the interfacial resistance is reduced to 31 Ω·cm². The half-cell obtained by employing the interface structure of “Embodiment 1 (“Example 1”) had significantly lower interfacial resistance and cell internal resistance. From this result, it has been found that the charge/discharge characteristics and the energy density of the battery are improved by employing half-cell obtained by employing the interface structure of “Embodiment 1 (“Example 1”).

Also, from the AC impedance spectra obtained after performing the initial charges of the half-cells obtained in “Embodiment 4” (“Example 4”), “Embodiment 5” (“Example 5”) “Embodiment 6” (“Example 6”), and “Embodiment 7 (“Example 7”), it has been confirmed that even in the structures, each of which sandwiches an indium (In) layer, a silver (Ag) layer, a platinum (Pt) layer, or a silicon (Si) layer, the interfacial resistances thereof are 180 Ω·cm², 330 Ω·cm², 955 Ω·cm², and 67 Ω·cm² in order, which are significantly lower than the interfacial resistance (i.e., 3188 Ω·cm²) of the half-cell obtained in “Comparative Example 1” (“Example 8”). As a result, it has been confirmed that the interfacial resistances of the above structures are also reduced, similar to the case of the structure that sandwiches a gold layer.

(X-Ray Diffraction Measurement after Initial Charge Test)

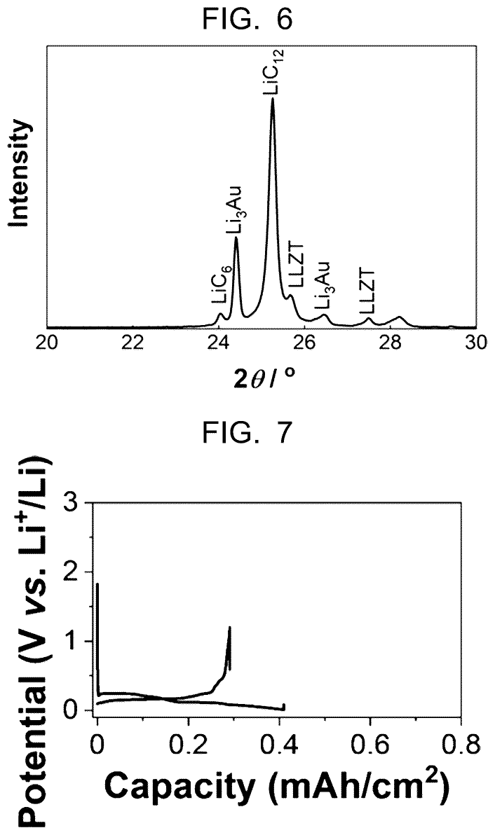

After an initial charge test was performed by using the half-cell 102 obtained in “Embodiment 2” (“Example 2”), the half-cell 102 was disassembled in a glove box under an argon gas atmosphere, the surface of the graphite layer that had been in contact with the current collector 21 was directed to the X-ray irradiation side, and was sealed in an atmosphere separator for X-ray diffraction (manufactured by Rigaku Corporation) (argon gas atmosphere), and X-ray diffraction measurement was performed in a diffraction angle range of 20° to 30° (20) by means of an X-ray diffraction device (manufactured by Rigaku Corporation, Miniflex 600). The X-ray diffraction pattern obtained as a result of the test is shown in FIG. 6.

(X-Ray Diffraction Measurement Results after Initial Charge Test)

From the X-ray diffraction pattern obtained after performing the initial charge of the half-cell 102 obtained in “Embodiment 2” (“Example 2”), it has been found that the gold layer reacts with lithium and changes into an alloy Li₃Au. From this, it has been found that the phenomenon that it is confirmed that the interfacial resistance is reduced in the structure that sandwiches the gold layer of the low-resistance layer 23 between the test electrode 22 and the separator layer 25 is due to the large contribution of volume expansion during the alloying reaction. Additionally, it has been found that lithium is inserted into the graphite contained in the graphite layer near the current collector from the stage 2 to the stage 1 charging state, even in CC charging using a current value of 0.05 C at room temperature by reducing the interfacial resistance.

### (Charge/Discharge Cycle Test)

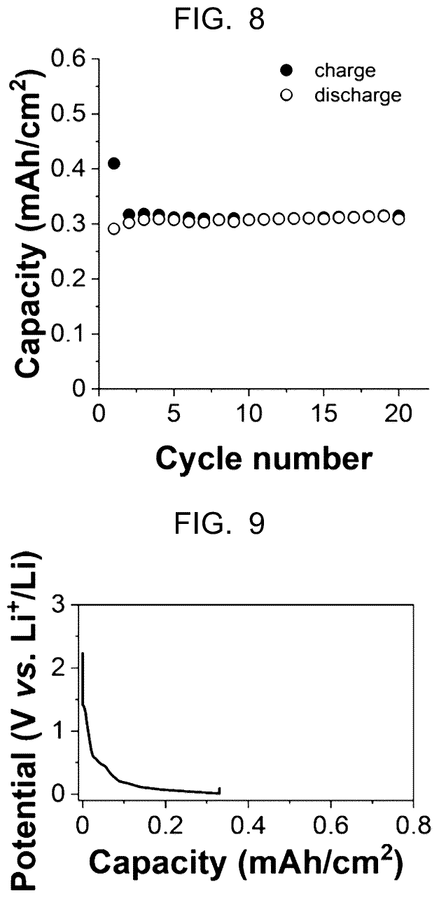

By using the half-cell 102 obtained in “Embodiment 3” (“Example 3”), a charge/discharge test was performed at a current value of 0.05 C in a voltage range of 0.01 to 1.2 V based on lithium metal. FIG. 7 shows the initial charge/discharge curve obtained as a result of the test, and FIG. 8 shows the battery capacity versus the number of charge/discharge cycles up to 20 cycles. Here, the test environment is a room temperature argon atmosphere at approximately 25° C. under atmospheric pressure.

### (Charge/Discharge Cycle Test Results)

From the initial charge/discharge curve of the half-cell 102 obtained in “Embodiment 3” (“Example 3”), it has been found that no large hysteresis is observed in the charge/discharge curve, and that the initial Coulombic efficiency is a value exceeding 70%. Also, from the facts that high reversibility is observed in the second and subsequent cycles and no noticeable capacity loss is observed, it has been found that the half-cell 102 obtained by employing the interface structure of the present disclosure exhibits not only high energy density but also high stability.

Furthermore, embodiments from “Examples 9 to 20” were added hereto as shown below. Samples prepared in the additional embodiments are twelve types shown in “Examples 9 to 20”. In the additional embodiments, as in the cases of the above embodiments (that is, “Examples 1 to 8”), for the purpose of eliminating the influence of the positive electrode that is used in the all-solid-state lithium-ion secondary battery and investigating the interface bonding due to the graphite negative electrode active material alone, the all-solid-state lithium-ion half-cell 102 (see FIG. 2) was prepared by using the graphite (in which a material containing the graphite as a main component is also included) for the test electrode 22, a LiLaZrTaO sintered body as the separator layer 25, and lithium foil as the counter electrode 26, and the characteristics thereof were evaluated. The low-resistance layer 23 is made of gold (Au) in “Examples 9, 10, and 17 to 20”, indium (In) in “Examples 11 and 12”, silver (Ag) in “Examples 13 and 14”, and platinum (Pt) in “Examples 15 and 16”. In “Example 17”, the test electrode 22 was not disposed, and in “Example 18”, a half-cell was prepared by incorporating the test electrode 22 that was made of graphite and silicon. And, the characteristics of them were evaluated.

“Examples 19 and 20” are negative electrodes that were prepared to evaluate the element distribution in the thickness direction of the test electrode 22. In Example 19, the test electrode 22 is made of graphite, and in Example 20, the test electrode 22 is made of graphite and silicon.

Here, as in the above Embodiments (that is, “Examples 1 to 8”), the method for preparing the sample will be summarized first, and then the characteristics thereof will be summarized. In this case, for comparison, “Example 3 (that is, “Embodiment 3”) and “Example 8” (that is, “Comparative Example 1”) described in the above Embodiments are also used as appropriate.

### Sample Preparation

### Example 9

### (Solid Electrolyte)

As the separator layer 25 (i.e., solid electrolyte), a sintered body of Li_{6.6}La₃Zr_{1.6}Ta_{0.4}O₁₂ (manufactured by Toshima Manufacturing Co., Ltd.) having a diameter of 10 mm and a thickness of 2 mm was used.

### (Graphite Dispersion Liquid)

As a graphite dispersion liquid, the dispersion liquid in which graphite powders (manufactured by IMERYS S.A., KS6, average diameter 4.4 μm) of 450 mg were dispersed in 99.5% ethanol (manufactured by FUJIFILM Wako Pure Chemical Corporation) of 30 g was used.

### (Preparation Step)

First, the graphite dispersion liquid was spray-coated on an unpolished SUS304 disk having a diameter of 10 mm and a thickness of 0.5 mm by means of a small spray coating device (manufactured by ACing Technologies Co., Ltd., model AV-8), thereby obtaining the test electrode 22 made of the graphite of which a coating amount was 1.231 mg/cm².

Next, by means of a compact sputtering device (manufactured by Sanyu Industries Co., Ltd., SC-701MkII ADVANCE), a gold (Au) layer having a weight of 0.29 mg/cm² was formed on each of the main surfaces of the solid electrolyte sintered body (diameter 10 mm, thickness 2 mm) that forms the separator layer 25. Here, the gold layer on the side in contact with the test electrode 22 corresponds to the low-resistance layer 23. Therefore, the low-resistance layer 23 of “Example 9” is formed of a gold layer having a thickness of 150 nm.

Thereafter, a 50 μm-thick lithium (Li) foil (manufactured by Honjo Chemical Corporation) was prepared as the counter electrode 26, and the lithium foil was disposed on one surface of the solid electrolyte 25 coated with a gold layer. Subsequently, the test electrode 22 made of the graphite was disposed on the other surface of the solid electrolyte 25 coated with a gold layer, which became the low-resistance layer 23.

After then, a primary assembly was obtained by combining: the test electrode 22 made of the graphite; the solid electrolyte 25, both surfaces of which were coated with a gold layer; and the counter electrode 26 (specifically, Li foil). Also, in “Example 9”, the SUS304 used in the spray-coated substrate was used as the current collector 21, and an unpolished SUS304 disk having a diameter of 10 mm and a thickness of 0.5 mm was newly used as the current collector 27 and was disposed on one surface of the counter electrode 26 (i.e., Li foil).

### (Pressurizing Step)

The half-cell 102 of “Example 9” was obtained by screw-tightening the obtained primary assembly with a torque of 2.0 Nm and applying a confining pressure of 40 MPa in the stacking direction.

TABLE 4

| | Graphite Layer | Remarks |
|---|---|---|
| Example 9 | 1.231 mg/cm² | Embodiment |
| Example 3 | 1.307 mg/cm² | |
| Example 10 | 1.231 mg/cm² | |
| Example 11 | 1.138 mg/cm² | |
| Example 12 | 1.037 mg/cm² | |
| Example 13 | 1.092 mg/cm² | |
| Example 14 | 1.023 mg/cm² | |
| Example 15 | 1.152 mg/cm² | |
| Example 16 | 1.389 mg/cm² | |
| Example 7 | 1.394 mg/cm² | |
| Example 19 | 1.316 mg/cm² | |
| Example 8 | 1.050 mg/cm² | Comparative |
| | | Example |

### Example 10

The half-cell 102 of “Example 10” was obtained in the same manner as in “Example 9” except that the surface facing the test electrode 22 made of the graphite in “Example 9” was coated with a gold (Au) layer having a weight of 0.05 mg/cm² and the coating amount of graphite powder was changed as shown in Table 4. Therefore, the low-resistance layer 23 of “Example 10” is formed of a gold layer having a thickness of 26 nm.

TABLE 5

| | | Weight | Thickness | | |
|---|---|---|---|---|---|
| | Low- | of Low- | of Low- | | |
| | Resistance | Resistance | Resistance | | |
| | Layer | Layer | Layer | | Remarks |
| Example 9 | Gold | 0.29 mg/cm² | 150 | nm | Embodiment |
| Example 3 | Gold | 0.29 mg/cm² | 150 | nm | |
| Example 10 | Gold | 0.05 mg/cm² | 26 | nm | |
| Example 11 | Indium | 0.08 mg/cm² | 109 | nm | |
| Example 12 | Indium | 0.01 mg/cm² | 14 | nm | |
| Example 13 | Silver | 0.11 mg/cm² | 104 | nm | |
| Example 14 | Silver | 0.03 mg/cm² | 29 | nm | |
| Example 15 | Platinum | 0.16 mg/cm² | 75 | nm | |
| Example 16 | Platinum | 0.04 mg/cm² | 19 | nm | |
| Example 7 | Silicon | 0.06 mg/cm² | 258 | nm | |
| Example 17 | Gold | 0.34 mg/cm² | 175 | nm | |
| Example 18 | Gold | 0.29 mg/cm² | 150 | nm | |

### Example 11

The half-cell 102 of “Example 11” was obtained in the same manner as in “Example 9” except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with an indium (In) layer having a weight of 0.08 mg/cm²; and the coating amount of the graphite powders was changed as shown in Table 4. Therefore, the low-resistance layer 23 of “Example 11” is formed of an indium layer having a thickness of 109 nm.

### Example 12

The half-cell 102 of “Example 12” was obtained in the same manner as in “Example 11” except that the surface of the sintered body 25 of the solid electrolyte facing the test electrode 22 made of the graphite was coated with an indium (In) layer having a weight of 0.01 mg/cm² and the coating amount of the graphite powders was changed as shown in Table 4. Therefore, the low-resistance layer 23 of “Example 12” is formed of an indium layer having a thickness of 14 nm.

### Example 13

The half-cell 102 of “Example 13” was obtained in the same manner as in “Example 9” except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with a silver (Ag) layer having a weight of 0.11 mg/cm²; and the coating amount of the graphite powders was changed as shown in Table 4. Therefore, the low-resistance layer 23 of “Example 13” is formed of a silver layer having a thickness of 104 nm.

### Example 14

The half-cell 102 of “Example 14” was obtained in the same manner as in “Example 13” except that the surface of the sintered body 25 of the solid electrolyte facing the test electrode 22 made of the graphite was coated with a silver (Ag) layer having a weight of 0.03 mg/cm² and the coating amount of the graphite powders was changed as shown in Table 4. Therefore, the low-resistance layer 23 of “Example 14” is formed of a silver layer having a thickness of 29 nm.

### Example 15

The half-cell 102 of “Example 15” was obtained in the same manner as in “Example 9” except for the following: only one surface of the sintered body 25 of the solid electrolyte on which the lithium foil serving as the counter electrode 26 was disposed was coated with a gold layer; the other surface of the sintered body 25 of the solid electrolyte on which the test electrode 22 made of the graphite was disposed, that is, the surface facing the test electrode 22, was coated with a platinum (Pt) layer having a weight of 0.16 mg/cm²; and the coating amount of the graphite powders was changed as shown in Table 4. Therefore, the low-resistance layer 23 of “Example 15” is formed of a platinum layer having a thickness of 75 nm.

### Example 16

The half-cell 102 of “Example 16” was obtained in the same manner as in “Example 15” except that the surface of the sintered body 25 of the solid electrolyte facing the test electrode 22 made of the graphite was coated with a platinum (Pt) layer having a weight of 0.04 mg/cm² and the coating amount of the graphite powders was changed as shown in Table 4. Therefore, the low-resistance layer 23 of “Example 16” is formed of a platinum layer having a thickness of 19 nm.

### Example 17

The half-cell 102 of “Example 17” was obtained in the same manner as in “Example 9” except that the weight of the gold layer of the low-resistance layer 23 was changed to 0.34 mg/cm² and the current collector 21 was disposed next to the metal layer of the low-resistance layer 23. Therefore, “Example 17” does not have the test electrode 22, and the low-resistance layer 23 thereof is formed of a gold layer having a thickness of 175 nm.

### Example 18

The half-cell 102 of “Example 18” was obtained in the same manner as in “Example 9” except for the following: the graphite dispersion liquid was changed to a graphite-silicon dispersion liquid, thereby being spray-coated; the test electrode 22 made of the graphite and the silicon, of which a coating amount was 1.37 mg/cm², was incorporated; and the weight of the gold layer of the low-resistance layer 23 was changed as shown in Table 5.

### (Graphite-Silicon Dispersion Liquid)

As the above graphite-silicon dispersion liquid, the dispersion liquid in which graphite powders (manufactured by IMERYS S.A., KS6, average diameter 4.4 μm) of 450 mg and silicon powders having 50 nm diameter (manufactured by Alfa Aesar) of 45 mg were dispersed in 99.5% ethanol (manufactured by FUJIFILM Wako Pure Chemical Corporation) of 30 g was used. The molar ratio of dispersed graphite to silicon is 95:5.

### Example 19

The negative electrode (i.e., negative electrode layer) constituted by only the test electrode 22 made of the graphite and the current collector 21, which was an unpolished SUS304 disk having a diameter of 10 mm and a thickness of 0.5 mm, was obtained in the same manner as in “Example 9” except that the coating amount of the graphite powders was changed as shown in Table 4.

### Example 20

The negative electrode (i.e., negative electrode layer) constituted by only the test electrode 22 made of the graphite and the silicon and the current collector 21, which was an unpolished SUS304 disk having a diameter of 10 mm and a thickness of 0.5 mm, was obtained in the same manner as in Example 18 except that the coating amount of the test electrode 22 made of the graphite and the silicon was changed to 1.717 mg/cm².

### [Characteristics Evaluation]

### (Initial Charge Test)

By using the half-cells 102 obtained in “Example 9”, “Examples 10 to 16”, “Example 18”, and “Example 8”, a CC charge test was performed at a current value of 0.05 C until the voltage reached 0.01 V based on lithium metal. The value of each C rate was calculated from the coating amount of the graphite of the test electrode 22. Regarding the half-cell obtained in “Example 18”, calculations were performed by estimating the coating amount of the graphite based on the assumption that coating was performed in a state where the weight ratio of the graphite and the silicon that were dispersed in the graphite-silicon dispersion liquid used for spray coating was maintained at 10:1 (specifically by estimating to be 1.243 mg/cm²).

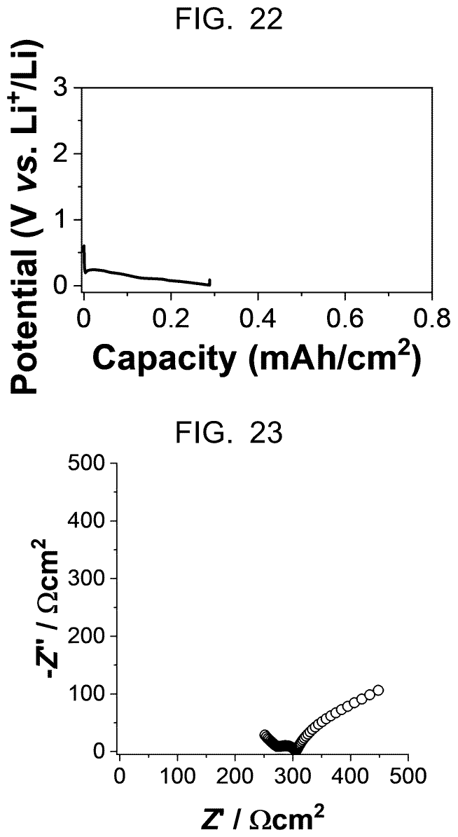

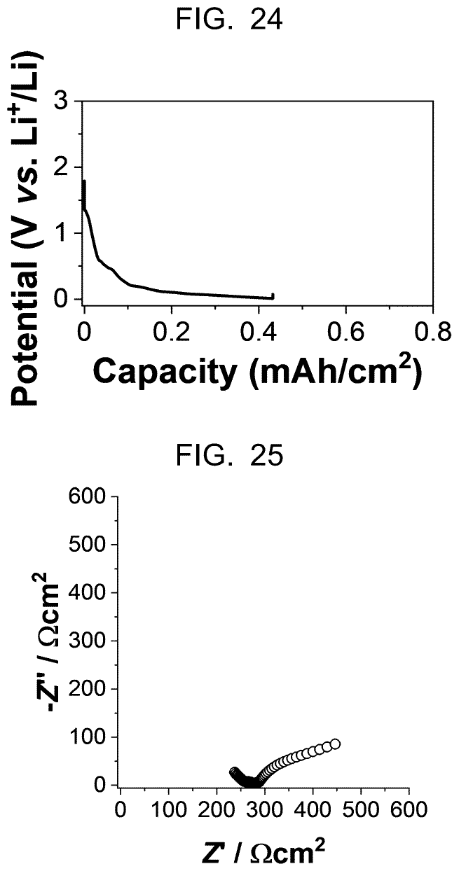

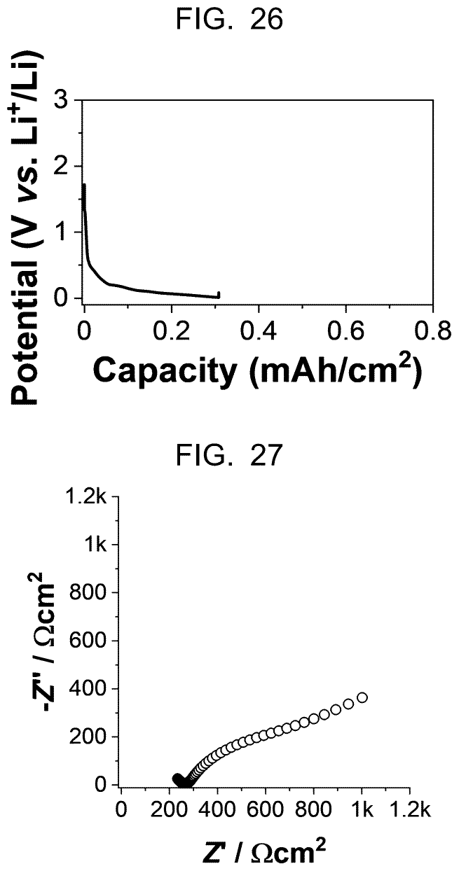

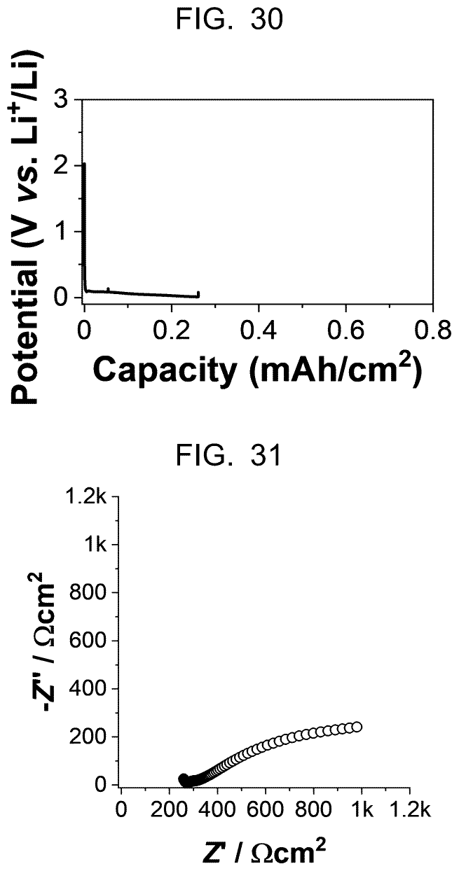

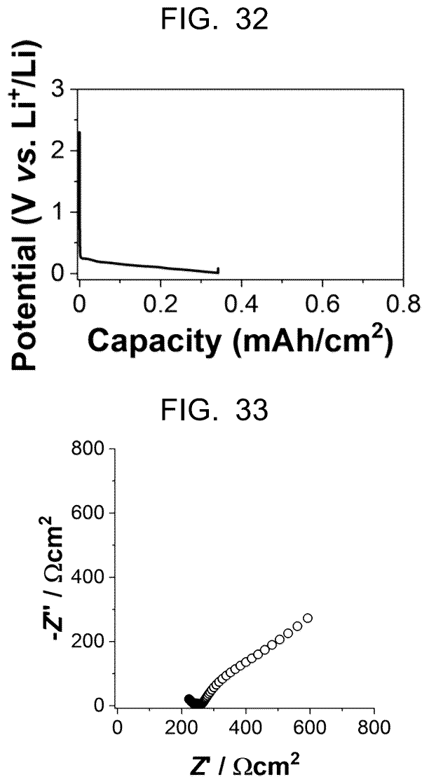

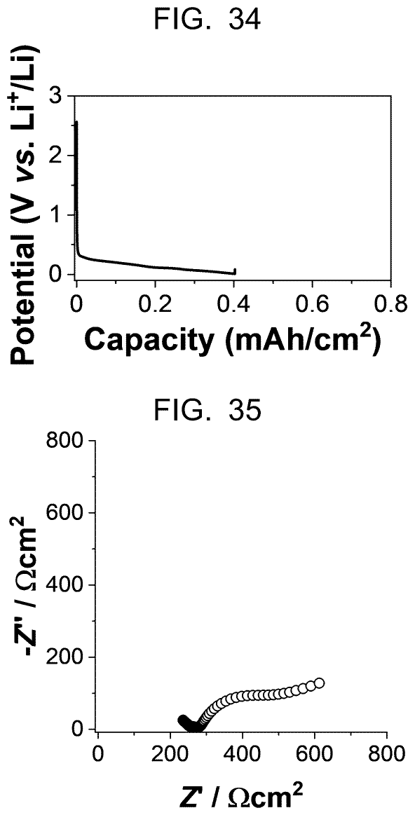

The initial charge curves obtained as a result of the test are shown in FIGS. 19, 22, 24, 26, 28, 30, 32 and 34, respectively.

Also, by using the half-cell 102 obtained in “Example 7”, CC charging was continuously performed at current values of 0.0005 C for 12 hours and 0.005 C for 10 hours, and then CC charging was performed at a current value of 0.05 C until the voltage reached 0 V based on lithium metal. Subsequently, a CV charge test was continuously performed at 0 V for 10 hours. The initial charge curve obtained from the test results is shown in FIG. 15. Here, the test environment is a room temperature argon atmosphere at approximately 25° C. under atmospheric pressure.

### (Initial Charge Test Results)

The test results of the initial charge capacity are shown in Table 6.

TABLE 6

| | Test | | | |
|---|---|---|---|---|
| | Electrode | Low- | Charge | |
| | Active | Resistance | Capacity | |
| | Material | Layer | (mAh/cm²) | Remarks |
| Example 9 | Graphite | Gold | 0.513 | Embodiment |
| Example 10 | Graphite | Gold | 0.289 | |
| Example 11 | Graphite | Indium | 0.432 | |
| Example 12 | Graphite | Indium | 0.308 | |
| Example 13 | Graphite | Silver | 0.420 | |
| Example 14 | Graphite | Silver | 0.261 | |
| Example 15 | Graphite | Platinum | 0.342 | |
| Example 16 | Graphite | Platinum | 0.403 | |
| Example 7 | Graphite | Silicon | 0.611 | |
| Example 18 | Graphite, silicon | Gold | 1.124 | |
| Example 8 | Graphite | — | 0.109 | Comparative |
| | | | | Example |

The weight of the graphite contained in the test electrode 22 that was made of the graphite and that was incorporated into each of the half-cells 102 obtained in “Example 9”, “Example 10”, and “Example 8” is approximately 1 mg/cm² and is almost the same in all cases. However, in “Examples 9 and 10” that disposed the test electrode 22 made of the graphite on the surface of the solid electrolyte 25 that was coated with a gold layer of the low-resistance layer 23, a charge capacity larger by approximately 0.2 to 0.4 mAh/cm² was obtained compared to “Example 8” that disposed the test electrode 22 made of the graphite on the surface of the solid electrolyte 25 that was not coated with a gold layer (i.e., “Example 8” in which no low-resistance layer 23 was disposed).

Also, the weight of the graphite contained in the test electrode 22 that was made of the graphite and the silicon and that was incorporated into the half-cell 102 obtained in “Example 18” and the weight of the gold layer of the low-resistance layer 23 were almost the same as the weight of the graphite contained in the test electrode 22 that was made of the graphite and that was incorporated into the half-cell obtained in “Example 9” and the weight of the gold layer of the low-resistance layer 23, respectively. However, it has been found that in “Example 18”, the charge capacity that becomes to be nearly twice as large as the charge capacity obtained in “Example 9” can be provided.

The weight of the graphite contained in the test electrode 22 that was made of the graphite and that was incorporated into each of the half-cells 102 obtained in “Examples 11 to 16” and “Example 8” were also almost the same in all cases. However, in “Examples 11 to 16”, each of which disposed the test electrode 22 made of the graphite on the surface of the solid electrolyte 25 that was coated with an indium layer, a silver layer, or a platinum layer, a charge capacity larger by approximately 0.2 to 0.3 mAh/cm² was obtained compared to “Example 8” that disposed the test electrode 22 made of the graphite on the surface of the solid electrolyte 25 that was not coated with any of the above layers. That is, even when an indium layer, a silver layer, or a platinum layer was disposed as the low-resistance layer 23, a large charge capacity of approximately 0.2 to 0.3 mAh/cm² was obtained compared to the case where no low-resistance layer 23 was disposed.

Furthermore, the weight of the graphite contained in the test electrode 22 that was made of the graphite and that was incorporated into each of the half-cells 102 obtained in “Examples 7 and 8” is also almost the same in all cases. However, in “Example 14” that disposed the test electrode 22 made of the graphite on the surface of the solid electrolyte 25 that was coated with a silicon layer of the low-resistance layer 23, CC charging was performed until the voltage reached 0 V based on lithium metal, and CV charging was further performed for 10 hours, a charge capacity larger by approximately 0.5 mAh/cm² was obtained compared to “Example 8” that disposed the test electrode 22 made of the graphite on the surface of the solid electrolyte 25 that was not coated with a silicon layer, and CC charging was performed until the voltage reached 0 V based on lithium metal, that is, “Example 8” in which no low-resistance layer 23 was disposed.

(AC Impedance Measurement Method after Initial Charge Test)

After the above initial charge tests were performed by using each of the half-cells 102 obtained in “Examples 9, 10 to 16, 7, 18, and 8”, AC impedance thereof was measured in the frequency range from 10 mHz to 1 MHz with an applied AC voltage of 10 mV based on the natural potential.

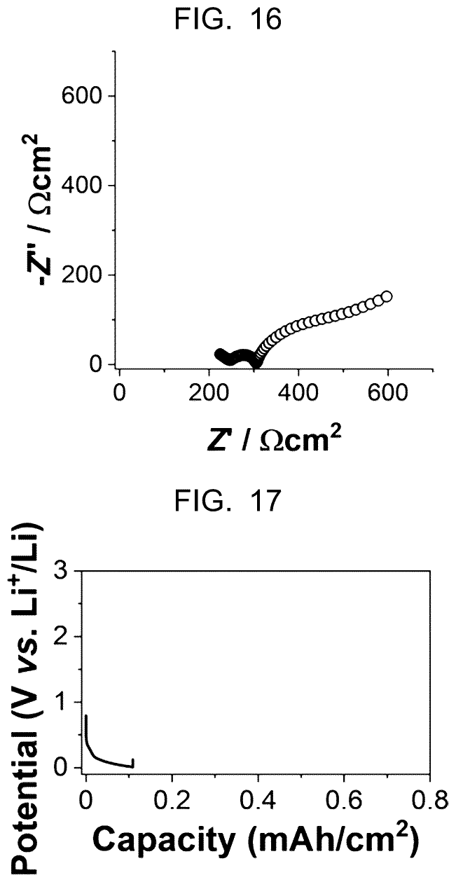

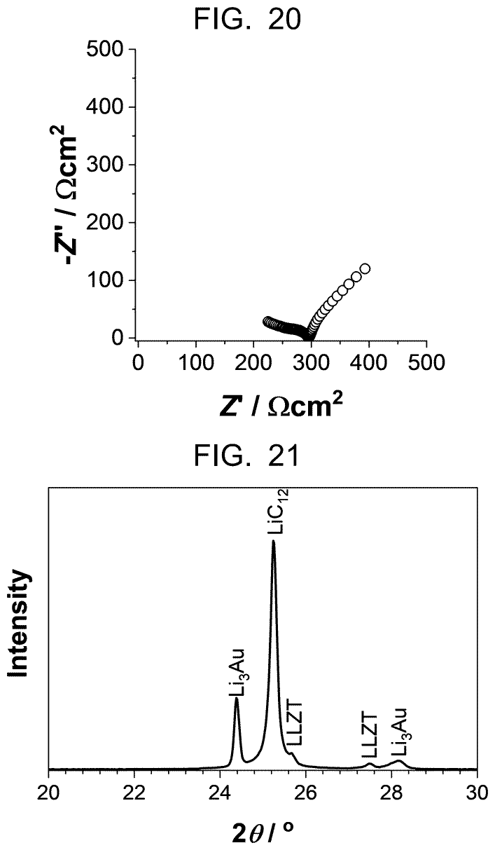

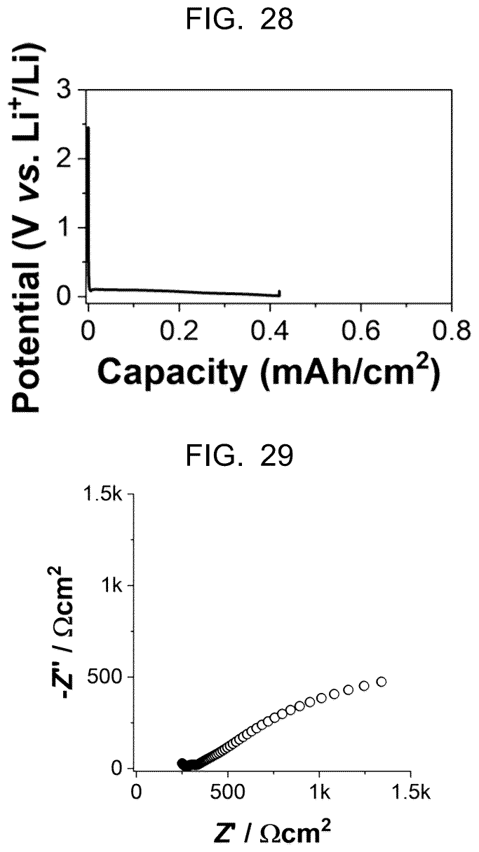

The AC impedance spectra obtained as a result thereof are shown in FIGS. 20, 23, 25, 27, 29, 31, 33, 35, 16, 39, and 18, respectively. Here, the test environment is a room temperature argon atmosphere at approximately 25° C. under atmospheric pressure.

### (AC Impedance Measurement Results After Initial Charge Test)

Table 7 shows the AC impedance measurement results after the initial charge test.

TABLE 7

| | Test | | Interfacial | |
|---|---|---|---|---|
| | Electrode | Low- | Resistance After | |
| | Active | Resistance | Initial Charge | |
| | Material | Layer | (Ω · cm²) | Remarks |
| Example 9 | Graphite | Gold | 31 | Embodiment |
| Example 10 | Graphite | Gold | 23 | |
| Example 11 | Graphite | Indium | 16 | |
| Example 12 | Graphite | Indium | 17 | |
| Example 13 | Graphite | Silver | 68 | |
| Example 14 | Graphite | Silver | 36 | |
| Example 15 | Graphite | Platinum | 21 | |
| Example 16 | Graphite | Platinum | 17 | |
| Example 7 | Graphite | Silicon | 67 | |
| Example 18 | Graphite, | Gold | 20 | |
| | silicon | | | |
| Example 8 | Graphite | — | 3,188 | Comparative |
| | | | | Example |

From the AC impedance spectra obtained after performing the initial charges of the half-cells 102 obtained in “Examples 9 and 10” and “Example 8”, it has been found that in a structure that does not sandwich a gold layer, the interfacial resistance of the test electrode 22 constituted by the solid electrolyte separator layer 25 and the graphite is 3188 22 cm², whereas in the structure that sandwiches the low-resistance layer 23 constituted by the gold layer, the interfacial resistance is reduced to approximately 30 Ω·cm². The half-cell obtained by employing the interfacial structure of “Example 9” had significantly lower interfacial resistance and cell internal resistance. From this result, it has been found that the charge/discharge characteristics and the energy density of the battery are improved by employing half-cell obtained by employing the interface structure of “Example 9”.

From the AC impedance spectra obtained after performing the initial charge of the half-cells 102 obtained in “Examples 11 to 16” and “Example 7”, it has been confirmed that even in the structures, each of which sandwiches an indium (In) layer, a silver (Ag) layer, a platinum (Pt) layer, or a silicon (Si) layer, the interfacial resistances thereof are approximately 20 to 70 Ω·cm² in order, which are significantly lower than the interfacial resistance (i.e., 3188 Ω·cm²) of the half-cell obtained in “Comparative Example 1” (“Example 8”). As a result, it has been confirmed that the interfacial resistances of the above structures are also reduced, similar to the case of the structure that sandwiches a gold layer.

Furthermore, the low-resistance layer 23 incorporated into each of the half-cells 102 obtained in “Examples 10, 12, 14, and 16” is formed of a metal layer having a thickness of 10 to 30 nm in all cases. However, it has been found that the above low-resistance layer 23 exhibits a low interfacial resistance that is almost the same as the interfacial resistances of “Examples 9, 11, 13, and 15”, in which corresponding metal layers having a thickness of 100 to 200 nm are incorporated.

Furthermore, from the AC impedance spectra obtained after performing the initial charge of the half-cell 102 obtained in “Example 18”, it has been found that in a structure that sandwiches the low-resistance layer 23 made of a gold layer, the interfacial resistance between the solid electrolyte separator layer 25 and the test electrode 22 made of the graphite and the silicon is 20 Ω·cm², which is almost the same as the interfacial resistances of the half-cells obtained in “Examples 9 and 10”.

(X-Ray Diffraction Measurement after Initial Charge Test)

After an initial charge test was performed by using each of the half-cells 102 obtained in “Examples 9 and 18”, the half-cell 102 was disassembled in a glove box under an argon gas atmosphere, the surface of the graphite layer that had been in contact with the current collector 21 was directed to the X-ray irradiation side, and was sealed in an atmosphere separator for X-ray diffraction (manufactured by Rigaku Corporation) (argon gas atmosphere), and X-ray diffraction measurement was performed in a diffraction angle range of 20° to 30° (2θ) by means of an X-ray diffraction device (manufactured by Rigaku Corporation, Miniflex 600). Each X-ray diffraction pattern obtained as a result of the tests is shown in FIGS. 5 and 28.

(X-Ray Diffraction Measurement Results after Initial Charge Test)

From the X-ray diffraction pattern obtained after performing the initial charge of the half-cell 102 obtained in “Example 9”, it has been found that the gold layer reacts with lithium and changes into an alloy Li₃Au. From this, it has been found that the phenomenon that it is confirmed that the interfacial resistance is reduced in the structure that sandwiches the gold layer of the low-resistance layer 23 between the test electrode 22 and the separator layer 25 is due to the large contribution of volume expansion during the alloying reaction. Additionally, it has been found that lithium is inserted into the graphite contained in the graphite layer near the current collector up to the stage 2 charging state, even in CC charging using a current value of 0.05 C at room temperature by reducing the interfacial resistance.

From the X-ray diffraction pattern obtained after performing the initial charge of the half-cell 102 obtained in “Example 18”, it has been found that the gold layer reacts with lithium and changes into an alloy Li₃Au, similar to “Example 9”. From this, it has been found that the phenomenon that it is confirmed that the interfacial resistance is reduced in the structure that sandwiches the gold layer of the low-resistance layer 23 between the test electrode 22 and the separator layer 25 is also due to the large contribution of volume expansion during the alloying reaction. However, unlike “Example 9”, it has been found that lithium is inserted into the graphite contained in the graphite-silicon layer near the current collector up to the stage 1 charging state in CC charging using a current value of 0.05 C at room temperature. From the facts that no peak from crystalline silicon is observed, it has been found that the silicon contained in the test electrode 22 reacts with lithium and changes into an amorphous lithium alloy. From these, it has been found that the phenomenon that it is confirmed that the charge depth of graphite increases in the structure containing a metal that causes a volume change by alloying with lithium in the test electrode 22 is due to the large contribution of volume expansion during the alloying reaction.

### (Element Distribution Measurement in Depth Direction of Negative Electrode Layer)

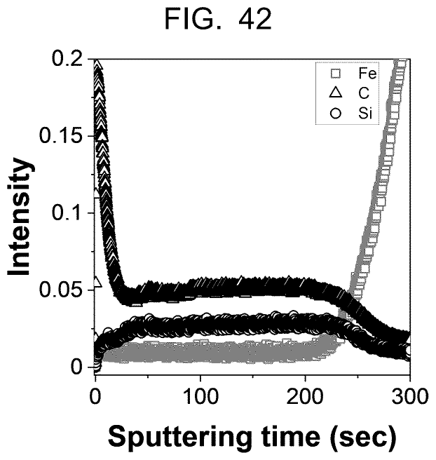

The element distribution in the depth direction of the negative electrode layer that was obtained in each of “Examples 19 and 20” and was constituted by the test electrode 22 and the current collector 21 was measured by means of a glow discharge optical emission spectrometer (GD-Profiler 2 manufactured by HORIBA, Ltd.). Each element distribution in the depth direction obtained as a result of the tests is shown in FIGS. 41 and 42. Sputtering was performed by means of a pulse method, and a two-kind mixed gas obtained by mixing argon (Ar) and oxygen (O₂) at a volume ratio of 95:5 was used as a sputtering gas. The sputtering area was 4 mm in diameter.

### (Element Distribution Measurement Results in Depth Direction of Negative Electrode Layer)

According to the element distribution in the depth direction of the negative electrode layer obtained in “Example 19”, a signal of iron (Fe) that shows a signal from the SUS disk of the current collector 21 was hardly observed until slightly before the signal of carbon (C) started to fall. Thus, it has been found that the test electrode 22 becomes a uniformly thick laminate of the graphite particles.

Even in the case where the element distribution in the depth direction of the negative electrode layer obtained in “Example 20”, a signal of iron (Fe) that shows a signal from the SUS disk of the current collector 21 was hardly observed until slightly before the signal of carbon (C) started to fall. Thus, it has been found that the test electrode 22 becomes a uniformly thick laminate of the graphite particles. Also, from the facts that the signal of silicon (Si) is continuously observed at a constant intensity until the signal of carbon starts to fall, it has been found that silicon is uniformly distributed in the test electrode 22.

### (Initial Charge Test of Low-Resistance Layer)

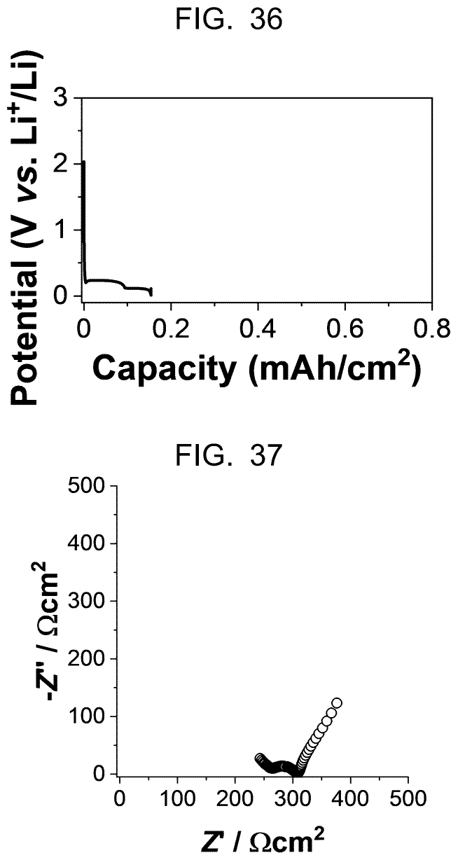

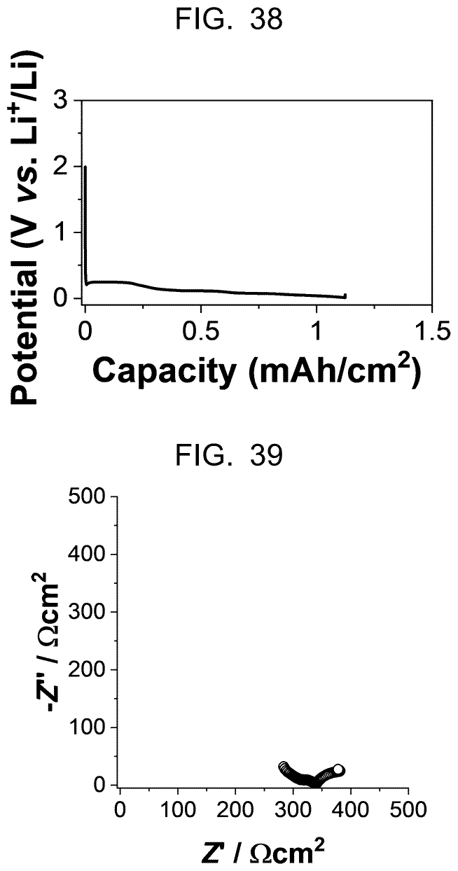

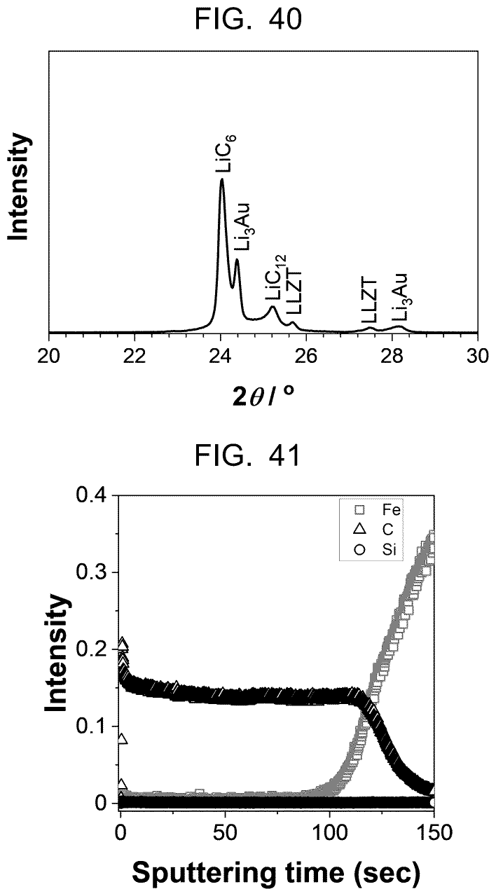

By using the half-cell 102 obtained in “Example 17”, a CC charge test was performed at a current value of 23.7 μA/cm² until the voltage reached 0.01 V based on lithium metal. The current value is the same as that of the case where the test electrode 22 made of the graphite, of which a coating amount when 1.00 mg of the graphite is applied to the current collector 21 having a diameter of 10 mm is 1.274 mg/cm² is charged at 0.05 C. That is, the current value is substantially the same as the current value used in “Example 9”. The initial charge curve obtained from the test results is shown in FIG. 36. Here, the test environment is a room temperature argon atmosphere at approximately 25° C. under atmospheric pressure.

### (Initial Charge Test Results of Low-Resistance Layer)

Although the test electrode 22 made of the graphite was not incorporated into the half-cell 102 obtained in “Example 17”, the gold layer of the low-resistance layer 23 reacted with lithium to be alloyed, and thus a charge capacity of 0.154 mAh/cm² was obtained.

### (AC Impedance Measurement Method After Initial Charge Test of Low-Resistance Layer)

After the above initial charge tests were performed by using the half-cell 102 obtained in “Example 17”, AC impedance thereof was measured in the frequency range from 10 mHz to 1 MHz with an applied AC voltage of 10 mV based on the natural potential.

The AC impedance spectrum obtained as a result of the test is shown in FIG. 37. Here, the test environment is a room temperature argon atmosphere at approximately 25° C. under atmospheric pressure.

### (AC Impedance Measurement Results After Initial Charge Test of Low-Resistance Layer)

The interfacial resistance determined from the AC impedance measurement results obtained after performing the initial charge test is 31 Ω·cm², and thus it has been found that this interfacial resistance is almost the same as that of the half-cell obtained in each of “Examples 9 and 10” in which a gold layer is used for the low-resistance layer 23 and the test electrode 22 made of the graphite is incorporated.

### (Initial Charge Capacity of Graphite Layer)

The half-cell 102 obtained in “Example 9” incorporates: the test electrode 22 made of the graphite, which reacts with lithium; and a gold layer of the low-resistance layer 23, which reacts with lithium. Therefore, the obtained charge capacity of 0.513 mAh/cm² includes the capacities of both active materials above. In the half-cell obtained in “Example 17”, only a gold layer of the low-resistance layer 23 is incorporated, and the weight thereof is almost the same as that in “Example 9”. Therefore, the charge capacity of 0.154 mAh/cm² indicated by the half-cell obtained in “Example 17” can be regarded as the charge capacity indicated by the gold layer of the low-resistance layer 23 among the charge capacities indicated by the half-cell obtained in “Example 9”. That is, in the half-cell 102 obtained in “Example 9”, the charge capacity of the test electrode 22 made of the graphite is 0.359 mAh/cm² (=0.513 mAh/cm²-0.154 mAh/cm²), and it has been found that charging with a weight capacity density of 291 mAh/g is achieved.

### (Initial Charge Capacity of Graphite-Silicon Layer)

The half-cell 102 obtained in “Example 18” incorporates: the test electrode 22 made of the graphite and the silicon, which react with lithium; and a gold layer of the low-resistance layer 23, which reacts with lithium. Therefore, the obtained charge capacity of 1.124 mAh/cm² includes the capacities of the three active materials. In the half-cell obtained in “Example 17”, only a gold layer of the low-resistance layer 23 is incorporated, and the weight thereof is almost the same as that in “Example 9”. Therefore, the charge capacity of 0.154 mAh/cm² indicated by the half-cell 102 obtained in “Example 17” can be regarded as the charge capacity indicated by the gold layer of the low-resistance layer 23 among the charge capacities indicated by the half-cell 102 obtained in “Example 18”. That is, in the half-cell 102 obtained in “Example 18”, the charge capacity of the test electrode 22 made of the graphite and the silicon is 0.970 mAh/cm² (=1.124 mAh/cm²-0.154 mAh/cm²). Also, from the coating amount of the silicon estimated based on the assumption that coating was performed in a state where the weight ratio of the graphite and the silicon that were dispersed in the graphite-silicon dispersion liquid used for spray coating was maintained at 10:1, when the charge capacity of 0.525 mAh/cm² calculated based on the assumption that the silicon was charged up to the theoretical capacity is regarded as the charge capacity indicated by silicon of the test electrode 22, the charge capacity indicated by graphite of the test electrode 22 is 0.445 mAh/cm², and it has been found that charging with a weight capacity density of 359 mAh/g can be achieved.

From the weight capacity density indicated by the test electrode 22 made of only the graphite in the half-cell 102 obtained in “Example 9”, it has been found that the graphite contained in the test electrode 22 obtained by mixing the graphite and the silicon at a molar ratio of 95:5 in the half-cell 102 obtained in “Example 18” exhibits a larger weight capacity density close to the theoretical capacity. This is consistent with the result indicating that lithium is inserted into the graphite to the stage 1 charging state in the X-ray diffraction pattern measured after performing the initial charge.

According to the measurement result of the element distribution in the depth direction of the negative electrode layer, silicon is uniformly distributed in the test electrode 22 made of the graphite and the silicon, prepared by means of spray coating using the graphite-silicon dispersion liquid. Also, from the results of the X-ray diffraction measurement after the initial charge, it has been already confirmed that after the charge, the silicon contained in the test electrode 22 reacts with lithium and changed into an amorphous silicon alloy. From these, it has been found that the phenomenon that the graphite exhibits a larger weight capacity density in the test electrode 22 in which the silicon is mixed with the graphite than the weight capacity density exhibited by the graphite in the test electrode 22 made of only the graphite is due to the following: the volume expansion during the alloying reaction of the silicon, and the formation of a network within the test electrode 22 due to the bonding between the alloy particles as seen in “Patent Literature 2” and “Non-Patent Literature 2”.

### (Charge/Discharge Cycle Test)

By using the half-cell 102 obtained in “Example 3”, a charge/discharge test was performed at a current value of 0.05 C in a voltage range of 0.01 to 1.2 V based on lithium metal. FIG. 7 shows the initial charge/discharge curve obtained as a result of the test, and FIG. 8 shows the battery capacity versus the number of charge/discharge cycles up to 20 cycles. Here, the test environment is a room temperature argon atmosphere at approximately 25° C. under atmospheric pressure.

### (Charge/Discharge Cycle Test Results)

From the initial charge/discharge curve of the half-cell 102 obtained in “Example 3”, it has been found that no large hysteresis is observed in the charge/discharge curve, and that the initial Coulombic efficiency is a value exceeding 70%. From the facts that high reversibility is observed in the second and subsequent cycles and no noticeable capacity loss is observed, it has been found that the half-cell 102 obtained by employing the interface structure disclosed in the present application exhibits not only high energy density but also high stability.

### INDUSTRIAL APPLICABILITY

The present invention relates to an all-solid-state lithium-ion secondary battery that is promising as a next-generation secondary battery for electric vehicles including hybrid vehicles, submarines, homes, and industries from the viewpoint of electric capacity, charge/discharge, large current characteristics, miniaturization, and safety. According to the present invention, an all-solid-state lithium-ion secondary battery having low internal resistance and excellent charge/discharge characteristics is provided. Therefore, it is considered that the present invention greatly contributes to industrial development.

### REFERENCE SIGNS LIST

11 Negative electrode current collector
12 Negative electrode active material layer (for example, graphite)
13 Low-resistance layer
14 Negative electrode (negative electrode layer)
15 Separator layer (all-solid-state electrolyte layer, solid electrolyte, or sintered body)
16 Positive electrode active material layer
17 Positive electrode current collector
18 Positive electrode (positive electrode layer)
21 Current collector
22 Test electrode (for example, graphite)
23 Low-resistance layer
25 Separator layer (all-solid-state electrolyte layer, solid electrolyte, or sintered body)
26 Counter electrode (lithium foil)
27 Current collector
101 All-solid-state lithium-ion secondary battery
102 All-solid-state lithium-ion half-cell

1: An all-solid-state lithium-ion secondary battery comprising at least a negative electrode layer, a separator layer, and a positive electrode layer, wherein:
the negative electrode layer contains a negative electrode active material containing graphite;
the separator layer contains an oxide solid electrolyte; and
a low-resistance layer is formed between the negative electrode layer and the separator layer,
wherein the low-resistance layer is made of a lithium alloy or contains a material that forms a lithium alloy by performing a secondary battery operation that causes a current to flow between the negative electrode layer and the positive electrode layer.

2: The all-solid-state lithium-ion secondary battery according to claim 1, wherein the low-resistance layer contains one or more elements selected from the group consisting of gold, silver, platinum, aluminum, tin, indium, germanium, lead, zinc, antimony, magnesium, silicon, cadmium, gallium, tellurium, and bismuth.

3: The all-solid-state lithium-ion secondary battery according to claim 1, wherein the low-resistance layer has a thickness of 1 to 500 nm.

4: The all-solid-state lithium-ion secondary battery according to claim 1, wherein the low-resistance layer contains one or more selected from the group consisting of gold, silver, platinum, tin, indium, and silicon.

5: The all-solid-state lithium-ion secondary battery according to claim 1, wherein the low-resistance layer is disposed in contact with the separator layer.

6: The all-solid-state lithium-ion secondary battery according to claim 1, wherein the low-resistance layer is disposed in contact with the negative electrode layer.

7: The all-solid-state lithium-ion secondary battery according to claim 1, wherein the solid electrolyte contained in the separator layer has a garnet-type crystal structure with high ionic conductivity or a garnet-type-like crystal structure with high ionic conductivity.

8: The all-solid-state lithium-ion secondary battery according to claim 1, wherein the solid electrolyte contained in the separator layer is made of a composite oxide containing Li and one or more selected from the group consisting of a ceramic having a garnet-type structure, a ceramic having a perovskite-type structure, and a ceramic having a LISICON-type structure.

9: The all-solid-state lithium-ion secondary battery according to claim 1, wherein the negative electrode active material is made of graphite.

10: The all-solid-state lithium-ion secondary battery according to claim 1, wherein the negative electrode active material contains graphite and a material that can occlude less than 10% of lithium ions.

11: The all-solid-state lithium-ion secondary batter according to claim 1, wherein:
the positive electrode layer contains a positive electrode active material; and
the positive electrode active material is made of one or more elements selected from the group consisting of a spinel-type lithium-manganese composite oxide represented by LiM¹ₓMn₂₋ₓO₄ (where M¹ is at least one element selected from the group consisting of Li, B, Mg, Ca, Sr, Ba, Ti, V, Cr, Fe, Co, Ni, Cu, Al, Sn, Sb, In, Nb, Mo, W, Y, Ru, and Rh, and 0.01≤x≤0.5), a layered compound represented by LiₓMn_{(1-y-x)}Ni_{y}M²_{z}O₍₂₋ₖ₎Fₗ (where M² is at least one element selected from the group consisting of Co, Mg, Al, B, Ti, V, Cr, Fe, Cu, Zn, Zr, Mo, Sn, Ca, Sr, and W, and 0.8≤x≤1.2, 0<y<0.5, 0≤z≤0.5, k+l<1, −0.1≤k≤0.2, and 0≤l≤0.1), a lithium-cobalt composite oxide represented by LiCo₁₋ₓM³ₓO₂ (where M³ is at least one element selected from the group consisting of Al, Mg, Ti, Zr, Fe, Ni, Cu, Zn, Ga, Ge, Nb, Mo, Sn, Sb, and Ba, and 0≤x≤0.5), a lithium-nickel composite oxide represented by LiNi₁₋ₓM⁴ₓO₂ (where M⁴ is at least one element selected from the group consisting of Al, Mg, Ti, Zr, Fe, Co, Cu, Zn, Ga, Ge, Nb, Mo, Sn, Sb, and Ba, and 0≤x≤0.5), an olivine-type composite oxide represented by LiM⁵₁₋ₓN¹ₓPO₄ (where M⁵ is at least one element selected from the group consisting of Fe, Mn, and Co, N¹ is at least one element selected from the group consisting of Al, Mg, Ti, Zr, Ni, Cu, Zn, Ga, Ge, Nb, Mo, Sn, Sb, and Ba, and 0≤x≤0.5), and a lithium-titanium composite oxide represented by Li₄Ti₅O₁₂.

12: A method for producing an all-solid-state lithium-ion secondary battery, the all-solid-state lithium-ion secondary battery according to claim 1, wherein the low-resistance layer is formed by one or more methods selected from the group consisting of a sputtering method, a vapor deposition method, a coating formation method, and a foil bonding method.
